(19) United States
(12) Patent Application Publication
(10) Pub. No.: US 2025/0028338 A1
(43) Pub. Date: Jan. 23, 2025

(54) ROBOT-FRIENDLY BUILDING, METHOD AND SYSTEM FOR MONITORING ROBOT OPERATION

(71) Applicant: NAVER CORPORATION, Seongnam-si (KR)

(72) Inventors: Hak Seung CHOI, Seongnam-si (KR); Ka Hyeon KIM, Seongnam-si (KR)

(73) Assignee: NAVER CORPORATION, Seongnam-si (KR)

(21) Appl. No.: 18/908,091

(22) Filed: Oct. 7, 2024

Related U.S. Application Data
(63) Continuation of application No. PCT/KR2023/004432, filed on Apr. 3, 2023.

(30) Foreign Application Priority Data
Apr. 7, 2022 (KR) 10-2022-0043570

(51) Int. Cl. G05D 1/692; G05D 107/60; G06T 11/00; G06T 11/60

(52) U.S. Cl. CPC G05D 1/692; G06T 11/001; G06T 11/60; G05D 2107/60; G06T 2200/24

(57) ABSTRACT

A method of monitoring a robot operation according to some example embodiments, includes receiving robot information from each of the robots through communication with the robots located in a building where the robots provide services, and displaying, on a display unit, a monitoring screen configured to monitor an operational situation of the robots located in the building. The monitoring screen including a building graphic object representing the building, and a state graphic object positioned around the building graphic object, the state graphic object representing state information on a robot located on each of a plurality of floors included in the building, the state information on the robot and a visual appearance of the state graphic object determined based on the robot information received from each of the robots.

### CROSS-REFERENCE TO RELATED APPLICATIONS

This U.S. non-provisional application is a continuation of and claims the benefit of priority under 35 U.S.C. § 365 (c) to International Application PCT/KR2023/004432, which has an international filing date of Apr. 3, 2023 and claims priority to Korean Patent Application No. 10-2022-0043570, filed Apr. 7, 2022, the entire contents of each of which are incorporated herein by reference in their entirety.

### BACKGROUND

### 1. Field

The present inventive concepts relate to a method and system for monitoring a robot operation that is capable of intuitively and quickly monitoring an operational situation of a plurality of robots providing services within a building through a single screen.

Further, the present inventive concepts relate to a method and system for monitoring a robot operation that is applicable to a robot-friendly building.

### 2. Description of the Related Art

With the advancement of technology, various service devices are emerging, particularly in recent times, there has been active development of technology for robots that perform various tasks or services.

Further, in recent years, with the advancements in artificial intelligence technology, cloud technology, and other related fields, it has become possible to control robots with greater precision and safety. As a result, the utility and the applications of robots are gradually increasing. For example, due to the advancement in technology, robots have reached a level where they can safely coexist with humans in indoor spaces.

Accordingly, recently, robots are replacing human tasks or jobs, and there is active research on various methods in which the robots directly provide services to humans, especially in indoor spaces.

For example, in public places such as airports, train stations, and shopping malls, robots are providing guidance services, while in restaurants, robots are offering serving services. Further, in office spaces, residential complexes, and the like, robots are providing delivery services for mail, packages, and more. In addition, robots are providing various services such as cleaning services, security services, and logistics services. The types and scope of services offered by robots are expected to increase exponentially in the future, and the level of service provision is also anticipated to continue advancing.

These robots provide various services not only in outdoor spaces but also within the indoor spaces of buildings such as offices, apartments, shopping malls, schools, hospitals, and recreational facilities. For example, robots are controlled to move within the indoor spaces of buildings and offer a wide range of services.

Meanwhile, in order to efficiently operate a plurality of robots providing services in a building, there is a need, or alternatively a desire to integrate and monitor a location and operational state of each of the plurality of robots providing services in the building.

Accordingly, to provide higher-level services using the robots within buildings, research is needed or desired not only on individual monitoring of each robot but also on methods for integrating and monitoring a plurality of robots present within the buildings.

### SUMMARY

A method and system for monitoring a robot operation according to some example embodiments of the present inventive concepts is directed to providing a user environment in which an overall operational situation for a plurality of robots providing services within a building can be intuitively recognized through a single screen.

According to some example embodiments, the method and system for monitoring a robot operation according to the present inventive concepts is directed to providing a user environment in which the operational situation of robots can be quickly identified based on each of a plurality of floors included in a building.

According to some example embodiments, the method and system for monitoring a robot operation according to the present inventive concepts is directed to providing a large amount of data related to a robot control in a structure that is extensible in a flexible form and easy for a user to understand.

According to some example embodiments, the method and system for monitoring a robot operation according to the present inventive concepts is directed to providing a user environment that enables rapid and efficient control of a robot in various situations related to the robot operation.

According to some example embodiments, a robot-friendly building according to the present inventive concepts is capable of managing a traveling of a robot providing services in a more systematic manner by organically controlling a plurality of robots and facility infrastructure using a cloud system that operates in conjunction with the plurality of robots. Therefore, the robot-friendly building according to the present inventive concepts can provide various services to humans more safely, quickly, and accurately.

According to some example embodiments of the present inventive concepts, a method of monitoring a robot operation includes receiving robot information from each of the robots through communication with the robots located in the building, and displaying, on a display unit, a monitoring screen configured to monitor an operational situation of the robots located in the building. The monitoring screen including a building graphic object representing the building, and a state graphic object positioned around the building graphic object, the state graphic object representing state information on a robot located on each of a plurality of floors included in the building, the state information on the robot and a visual appearance of the state graphic object may be determined based on the robot information received from each of the robots.

According to some example embodiments of the present inventive concepts, a system for operating a robot includes a communication unit configured to receive robot information from each of the robots through communication with the robots located in a building where the robots provide services, and a control unit configured to control a display unit to display a monitoring screen for monitoring an operational situation of the robots located in the building. The monitoring screen including a building graphic object representing the building, and a state graphic object positioned around the building graphic object, the state graphic object representing state information on a robot located on each of a plurality of floors included in the building, the state information on the robot and a visual appearance of the state graphic object may be determined based on the robot information received from each of the robots.

According to some example embodiments of the present inventive concepts, a non-transitory computer-readable recording medium storing a program, the program, when executed by one or more processes on an electronic device, is configured to cause the electronic device to perform receiving robot information from each of robots through communication with the robots located in a building where the robots provide services, and displaying, on a display unit, a monitoring screen configured to monitor an operational situation of the robots located in the building. The monitoring screen including a building graphic object representing the building, and a state graphic object positioned around the building graphic object, the state graphic object representing state information on a robot located on each of a plurality of floors included in the building, the state information on the robot and a visual appearance of the state graphic object may be determined based on the robot information received from each of the robots.

According to some example embodiments of the present inventive concepts, a building where a plurality of robots provide services is provided, the building including a plurality of floors having interior spaces in which the robots coexist with humans, and a communication unit configured to perform communication between the robots and a cloud server. The cloud server configured to receive robot information from each of the robots through communication with the robots located in the building, and display, on a display unit, a monitoring screen, the monitoring screen configured to monitor an operational situation of the robots located in the building. The monitoring screen including a building graphic object representing the building, and a state graphic object positioned around the building graphic object, the state graphic object representing state information on a robot located on each of a plurality of floors included in the building, the state information on the robot and a visual appearance of the state graphic object may be determined based on the robot information received from each of the robots.

According to some example embodiments of the present inventive concepts, a method and system for monitoring a robot operation can provide a large amount of information on the robots located in the building through a single monitoring screen by receiving robot information from each of the robots and providing a monitoring screen for monitoring the operational situation of the robots located in the building through communication with robots located in the building. Therefore, a user can be provided with a large amount of information on the robots located in a building through a single screen in an integrated manner and systematically identify a situation in which the building is linked to the robots.

According to some example embodiments of the present inventive concepts, a method and system for monitoring a robot operation can provide a monitoring screen that includes a building graphic object representing a building, and a state graphic object positioned around the building graphic object and representing state information on a robot located on each of a plurality of floors included in the building. Therefore, a user can perform integrated and efficient management across a plurality of robots located in a building by intuitively and quickly recognizing the number of robots operating on each floor of the building, a location of the robots, and an operational state of the robots with a just look at a single monitoring screen.

According to some example embodiments of the present inventive concepts, in a method and system for monitoring a robot operation, state information on the robots included in the monitoring screen and a visual appearance of the state graphic object can be determined based on robot information received from each of the robots located in the building. Therefore, a user can monitor the location and operational state of multiple robots intuitively and in real-time and immediately respond to any robot-related issues through a single monitoring screen.

According to some example embodiments of the present inventive concepts, a robot-friendly building can use technological convergence in which robotics, autonomous driving, AI, cloud technologies are fused and connected and provide a new space where these technologies, robots, and facility infrastructure provided in the building are organically combined.

According to some example embodiments of the present inventive concepts, a robot-friendly building is capable of systematically managing a traveling of a robot providing services in a more systematic manner by organically controlling a plurality of robots and facility infrastructure using a cloud server that operates in conjunction with the plurality of robots. Therefore, the robot-friendly building according to the present invention can provide various services to humans more safely, quickly, and accurately.

According to some example embodiments of the present inventive concepts, in a building, robots and humans can coexist naturally in the same space by controlling a traveling of the robots to take into account humans, in addition to taking into account tasks assigned to the plurality of robots disposed in the building and a situation in which the robots are moving.

### BRIEF DESCRIPTION OF THE DRAWINGS

FIGS. 1, 2, and 3 are conceptual views for describing a robot-friendly building according to some example embodiments.

FIGS. 4, 5, and 6 are conceptual views for describing a robot traveling in the robot-friendly building according to some example embodiments and a system for controlling various facilities provided in the robot-friendly building according to some example embodiments.

FIGS. 7 and 8 are conceptual views for describing a facility infrastructure provided in the robot-friendly building according to some example embodiments.

FIGS. 9 to 11 are conceptual views for describing a method of estimating a position of a robot traveling in the robot-friendly building according to some example embodiments.

FIG. 12 is a conceptual view for describing a system for monitoring a robot operation according to some example embodiments.

FIG. 13 is a flowchart for describing a method of monitoring a robot operation according to some example embodiments.

FIG. 14 is a conceptual view for describing a monitoring screen according to some example embodiments.

FIG. 15A is a conceptual view for describing robot information according to some example embodiments.

FIG. 15B is a conceptual view for describing a plurality of robot datasets grouped by floors according to some example embodiments.

FIG. 16A is a conceptual view for describing facility information according to some example embodiments.

FIG. 16B is a conceptual view for describing a plurality of facility datasets grouped by floors according to some example embodiments.

FIGS. 17, 18, and 19 are conceptual views for describing a state graphic object representing state information on a robot located on each of a plurality of floors included in a building according to some example embodiments.

FIG. 20 is a conceptual view for describing a monitoring screen that provides operational situation information on robots based on types of robots and facilities according to some example embodiments.

FIG. 21, FIG. 22A, FIG. 22B, FIG. 22C, FIG. 22D, FIG. 22E, and FIG. 22F are conceptual views for describing a monitoring screen that provides operational situation information on robots based on a particular floor according to some example embodiments.

FIGS. 23A, 23B, and 23C are conceptual views for describing a user interface for monitoring an operational situation of a robot, according to some example embodiments.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes ‘module’, ‘unit’, ‘part’, and ‘portion’ used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it will be understood that the accompanying drawings are provided only to allow those skilled in the art to easily understand the exemplary embodiments disclosed in the present specification, and the inventive concepts disclosed in the present specification are not limited by the accompanying drawings, and include all alterations, equivalents, and alternatives that are included in the spirit and the technical scope of the present inventive concepts.

Terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

Some example embodiments of the present inventive concepts relate to robot-friendly buildings, and proposes robot-friendly buildings in which humans and robots can safely coexist, and in which robots can provide beneficial services within the buildings.

Some example embodiments of the present inventive concepts provide methods of providing useful services to humans using robots, robot-friendly infrastructure, and various systems that control the same. In the building according to some example embodiments of the present inventive concepts, humans and a plurality of robots can coexist, and various infrastructures (or facility infrastructures) may be provided to allow the plurality of robots to move freely within the building.

In some example embodiments of the present inventive concepts, buildings are structures made for continuous habitation, living, working, etc., and may have various forms, such as commercial buildings, industrial buildings, institutional buildings, residential buildings, etc. According to some example embodiments, the buildings may be multi-story buildings having a plurality of floors, and single-story buildings as opposed to the multi-story building. However, in the present inventive concepts, an infrastructure or facility infrastructure applied to multi-story buildings are described as examples for convenience of description.

According to some example embodiments of the present inventive concepts, an infrastructure or facility infrastructure is a facility provided in a building for the provision of services, the movement of robots, the maintenance of functionality, the maintenance of cleanliness, and the like, which may be of various types and forms. For example, an infrastructure in a building may include mobility facilities (e.g., robotic pathways, elevators, escalators, etc.), charging facilities, communication facilities, cleaning facilities, structures (e.g., stairs, etc.), etc. In this specification, these facilities are referred to as facilities, infrastructure, or facility infrastructure, and in some cases the terms are used interchangeably.

Further, in the building according to some example embodiments of the present inventive concepts, at least one of the building, various facility infrastructures provided in the building, and the robot may be controlled in conjunction with each other so that the robot is able to safely and accurately provide various services in the building.

Some example embodiments of the present inventive concepts propose a building equipped with various facility infrastructures that is capable of providing a plurality of robots to travel within the building and provide mission (or task) specific services, and supporting standby or charging functions as needed or desired, as well as repair and cleaning functions for the robots. The building according to some example embodiments of the present inventive concepts provide an integrated solution (or a system) for robots, and the building may be referred to by various modifiers. For example, the building according to some example embodiments of the present inventive concepts may be described in various ways, such as: i) a building having infrastructure used by robots, ii) a building having robot-friendly infrastructure, iii) a robot-friendly building, iv) a building where robots and humans live together, v) a building providing various services using robots, and the like, but example embodiments are not limited thereto.

Meanwhile, the meaning of “robot-friendly” according to some example embodiments of the present inventive concepts is a building in which robots coexist, and more specifically, may mean that robots are allowed to travel, that robots provide services, that a facility infrastructure is established that robots are able to use, or that a facility infrastructure is established that provides functions required by robots (e.g., charging, repair, cleaning, etc.), but example embodiments are not limited thereto. For example, “robot-friendly”according to some example embodiments of the present inventive concepts may be used in the meaning of having an integrated solution for the coexistence of robots and humans.

Hereinafter, some example embodiments according to the present inventive concepts will be described in more detail with reference to the accompanying drawings.

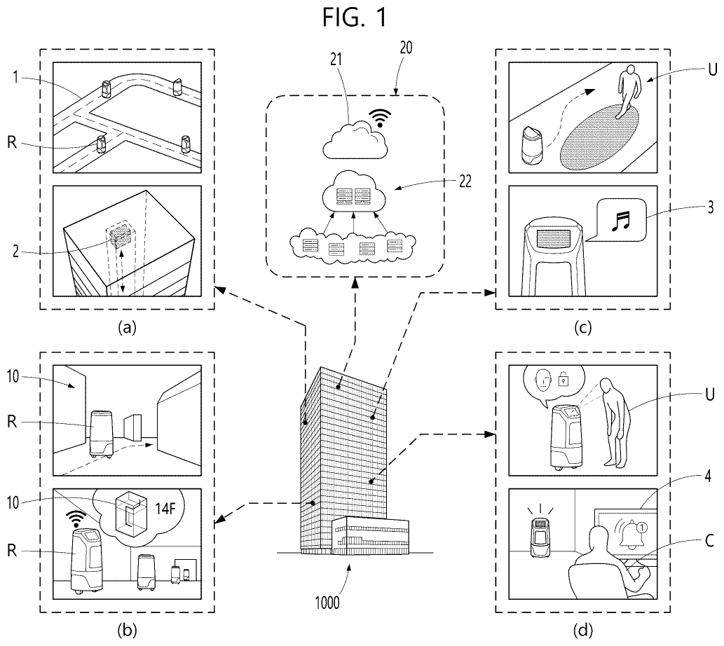

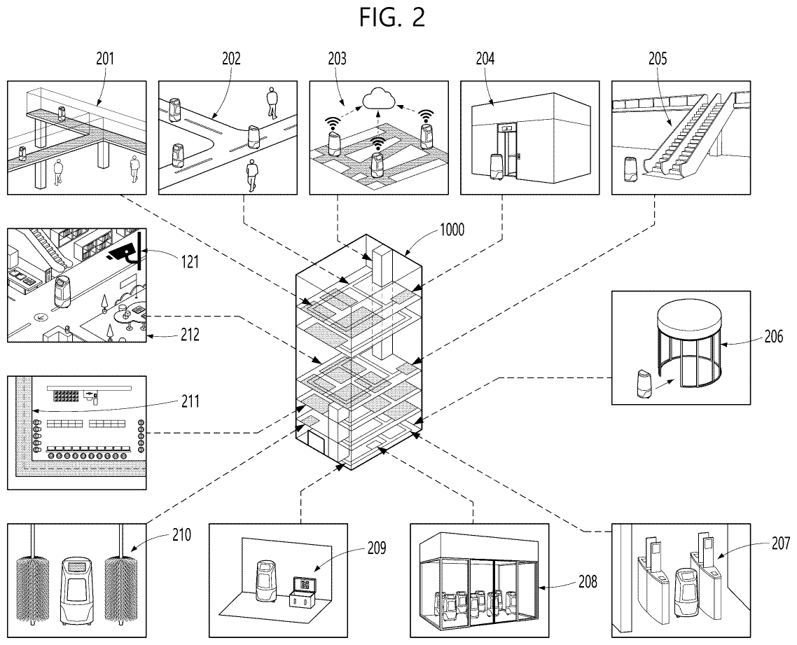

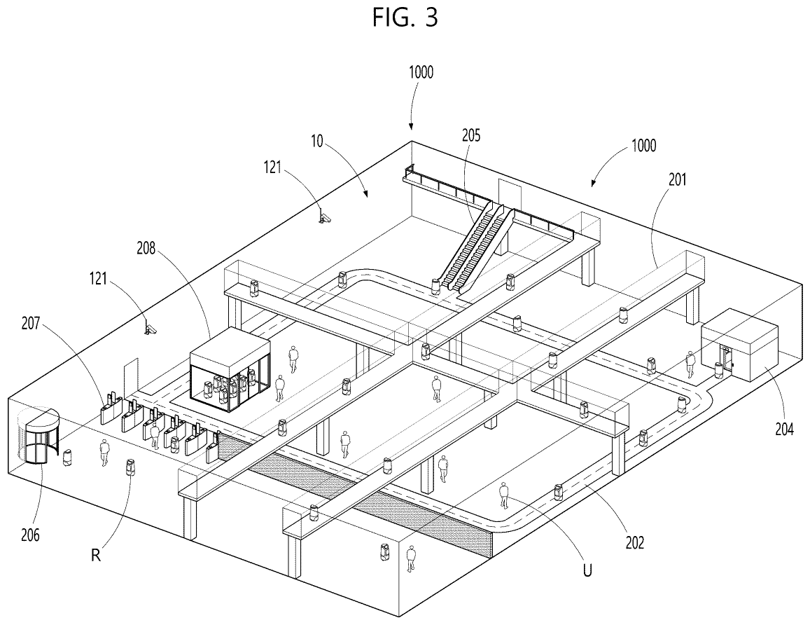

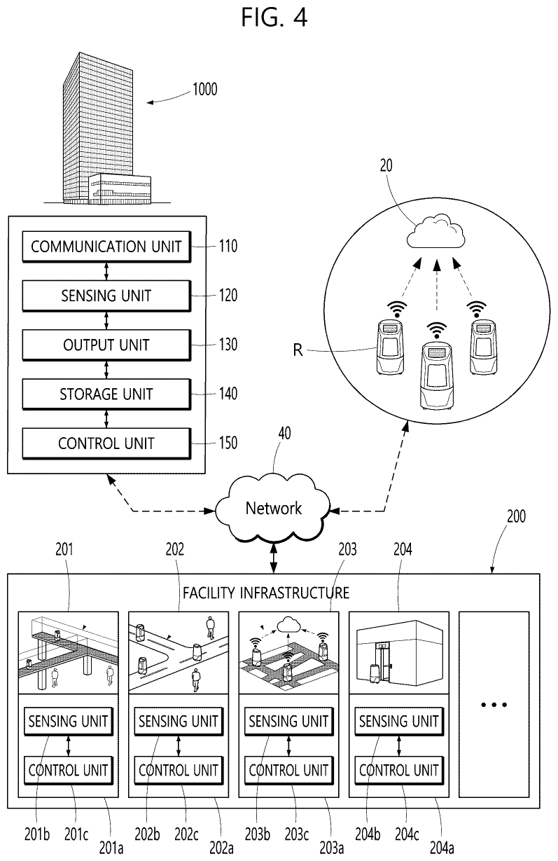

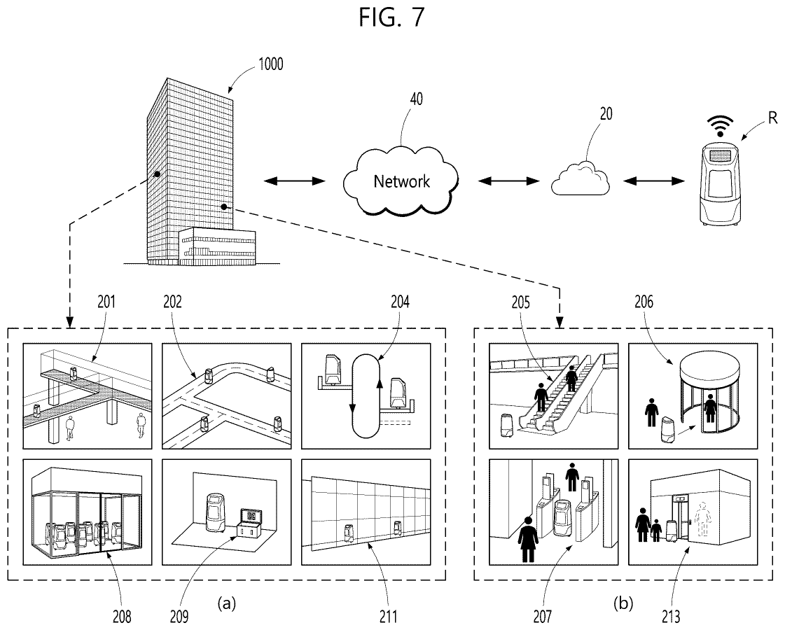

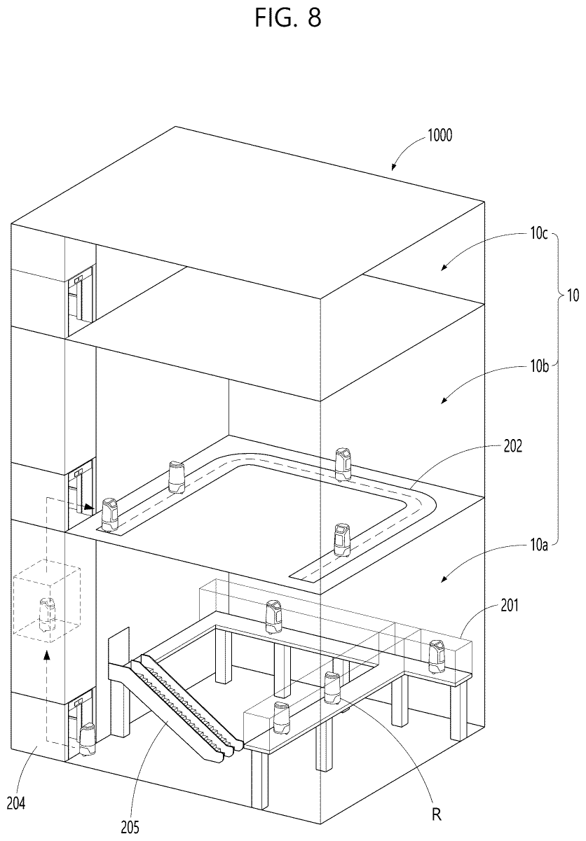

FIGS. 1, 2, and 3 are conceptual views for describing a robot-friendly building according to some example embodiments of the present inventive concepts, and FIGS. 4, 5, and 6 are conceptual views for describing a robot traveling in the robot-friendly building and a system for controlling various facilities provided in the robot-friendly building according to some example embodiments of the present inventive concepts. Further, FIGS. 7 and 8 are conceptual views for describing a facility infrastructure provided in the robot-friendly building according to some example embodiments of the present inventive concepts.

First, for convenience of description, the representative reference numerals will be defined.

In some example embodiments of the present inventive concepts, a building is given the reference numeral “1000” and a space (interior space or interior area) of the building 1000 is given the reference numeral “10” (see, e.g., FIG. 8). Further, interior spaces corresponding to each of a plurality of floors constituting interior spaces of the building 1000 are given the reference numerals 10a, 10b, 10c, and the like (see, e.g., FIG. 8). In some example embodiments of the present inventive concepts, the interior space or the interior area, is a concept as opposed to an exterior of the building, meaning an interior of the building protected by an exterior wall, and is not limited to meaning a space.

Further, in some example embodiments of the present inventive concepts, robots are given the reference numerals “R”, and all references to robots in the drawings or specification may be understood as robots (R), even if no reference numerals are given to the robots.

Furthermore, in some example embodiments of the present inventive concepts, a human or a person is given the reference numeral “U”, and a human or a person may be referred to as a dynamic object. In some example embodiments, the dynamic object does not necessarily mean a human, but may be taken to include an animal such as a dog or a cat, or at least one other robot (e.g., a user's personal robot, a robot providing another service, etc.), a drone, a cleaner (e.g., a robot cleaner), or any other object capable of moving.

Meanwhile, the building (building, structure, edifice, 1000) described in some example embodiments of the present inventive concepts is not limited to any particular type and, in some example embodiments, may mean a structure built for human occupancy, work, animal husbandry, or storage.

For example, the building 1000 may be an office, an office building, an apartment, a mixed-use apartment building, a house, a school, a hospital, a restaurant, a government building, and the like, and the present inventive concepts may be applicable to these various types of buildings.

As illustrated in FIG. 1, in the building 1000 according to some example embodiments, robots R can travel and provide various services.

A plurality of robots R of one or more different types may be located within the building 1000, and these robots R may, under control of the server 20, travel within the building 1000, provide services, and use the various facility infrastructure provided in the building 1000.

In some example embodiments of the present inventive concepts, a server 20 may be located at a variety of locations. For example, the server 20 may be located in at least one of an interior of the building 1000 and an exterior of the building 1000. In some example embodiments, at least a portion of the server 20 may be located inside the building 1000, and a remaining portion thereof may be located outside the building 1000. In some example embodiments, the server 20 may be located entirely inside the building 1000, or only outside the building 1000. Accordingly, in the present inventive concepts, there are no particular limitations on the specific location of the server 20.

Further, in some example embodiments of the present inventive concepts, the server 20 may be configured to use at least one of a server in a cloud computing method (cloud server, 21) and a server in an edge computing method (edge server, 22). According to some example embodiments, in addition to the cloud computing or edge computing methods, the server 20 may be applied in the present inventive concepts as long as the server uses a method that enables control of the robot R.

Meanwhile, the server 20 according to the present inventive concepts may, in some example embodiments, perform control of at least one of the robots R and the facility infrastructure provided in the building 1000 by mixing the server 21 of the cloud computing method with the edge computing method.

In some example embodiments, the robot R may be driven according to a control command. For example, the robot R may move a position or change a posture by changing a movement, and may perform a software update.

In the present inventive concepts, for convenience of description, the server 20 will be collectively referred to as a “cloud server” and will be given the reference numeral “20”. In some example embodiments the cloud server 20 may also be replaced by the term edge server 22 in edge computing.

Further, in some example embodiments, the term “cloud server” may be varied to include terms such as a cloud robot system, a cloud system, a cloud robot control system, a cloud control system, and the like.

According to some example embodiments of the present inventive concepts, the cloud server 20 may be capable of performing integrated control of a plurality of robots R traveling in the building 1000. For example, the cloud server 20 may, or may be configured to: i) perform monitoring of the plurality of robots R located in the building 1000; ii) assign missions (or tasks) to the plurality of robots R; iii) directly control facility infrastructure provided in the building 1000 to enable the plurality of robots R to successfully perform the missions; or iv) communicate with a control system that controls the facility infrastructure to enable the facility infrastructure to be controlled.

In some example embodiments, the cloud server 20 may identify state information on the robots R located in the building and provide (or support) various functions required by the robots R. In some example embodiments, the cloud server 20 may provide (or support) various functions that are desirable or advantageous for the robots to have. According to some example embodiments, different functions may include a charging function for robots R, a cleaning function for contaminated robots R, and a standby function for robots R that have completed missions, but example embodiments are not limited thereto.

The cloud server 20 may control the robots R to use various facility infrastructure provided in the building 1000 in order to provide various functions for the robots R. In some example embodiments, the cloud server may directly control the facility infrastructure provided in the building 1000, or may allow the facility infrastructure to be controlled through communication with the control system that controls the facility infrastructure, in order to provide various functions for the robots R. Additionally, any or all of the elements described with reference to the figures may communicate with any or all other elements described with reference to the figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus. The information may be encoded in various formats, such as in an analog format and/or in a digital format.

As described above, in some example embodiments, the robots R controlled by the cloud server 20 may travel in the building 1000 and provide various services.

According to some example embodiments, the cloud server 20 may perform various controls based on information stored in a database, and the present inventive concepts do not have particular limitations on types and locations of the database. It will be understood that the term database may be freely modified and used as long as it refers to the term for the means by which information is stored, such as a memory, a storage unit, a storage, a cloud storage, an external storage, an external server, etc. Hereinafter, the term “database” will be used throughout.

The cloud server 20 according to some example embodiments of the present inventive concepts may perform distributed control of the robots R based on various standards, such as types of services provided by the robots R, types of control of the robots R, and the like, in which case the cloud server 20 may have subordinate sub-servers of a sub-concept.

In some example embodiments, the cloud server 20 according to the present inventive concepts, may control the robot R traveling in the building 1000 based on various artificial intelligence algorithms.

According to some example embodiments, the cloud server 20 performs artificial intelligence-based learning that uses data collected in the process of controlling the robot R as learning data and utilizes the learning data to control the robot R, so that the more control is performed on the robot R, the more accurately and efficiently the robot R can be operated. For example, the cloud server 20 may be configured to perform deep learning or machine learning. In some example embodiments, the cloud server 20 may perform deep learning or machine learning through simulation or the like, and perform control of the robot R using the resulting artificial intelligence model. As described herein, any learning, learning models, machine learning models, or elements may, for example, use various artificial neural network organizations and processing models, the artificial neural network organizations including, for example, a convolutional neural network (CNN), a deconvolutional neural network, a recurrent neural network optionally including a long short-term memory (LSTM) and/or a gated recurrent unit (GRU), a stacked neural network (SNN), a state-space dynamic neural network (SSDNN), a deep belief network (DBN), a generative adversarial network (GAN), and/or a restricted Boltzmann machine (RBM), and/or the like; and/or include linear and/or logistic regression, statistical clustering, Bayesian classification, decision trees, and/or the like.

According to some example embodiments, the building 1000 may be provided with various facility infrastructures for traveling of the robot R, providing functions of the robot R, maintaining functions of the robot R, performing missions of the robot R, or coexistence of the robot R and human U, but example embodiments are not limited thereto.

For example, as illustrated in (a) of FIG. 1, the building 1000 may be provided with various facility infrastructures 1 and 2 that may support the traveling (or moving) of the robot R. These facility infrastructures 1 and 2 may support horizontal movement of the robot R within a floor of the building 1000, or may support vertical movement of the robot R between different floors of the building 1000. According to some example embodiments, the facility infrastructures 1 and 2 may include a transportation system to support the movement of the robot R. The cloud server 20 may allow the robot R to move within the building 1000 to provide services by controlling the robot R to use these various facility infrastructures 1 and 2, as illustrated in (b) of FIG. 1.

In some example embodiments, the robots R according to the present inventive concepts may be controlled based on at least one of the cloud server 20 and a control unit provided on the robot R itself, to perform travel within the building 1000 and/or to provide services corresponding to the assigned mission. As described herein, any devices, electronic devices, modules, units, and/or portions thereof according to any of the example embodiments, and/or any portions thereof (including without limitation, the control unit on the robot R) may include, may be included in, and/or may be implemented by one or more instances of processing circuitry such as hardware including logic circuits; a hardware/software combination such as a processor executing software; or a combination thereof.

In some example embodiments, as illustrated in (c) of FIG. 1, the building according to the present inventive concepts is a building in which robots R and humans U coexist, and the robots R may be configured to travel by avoiding obstacles such as humans U, objects used by humans U (e.g., strollers, carts, etc.), and animals, and may in some cases be configured to output notification information 3 related to the traveling of the robots R. The traveling of the robot R may be performed to avoid obstacles based on at least one of the cloud server 20 and the control unit provided on the robot R. The cloud server 20 may perform control of the robot R to move within the building 1000 to avoid obstacles based on information received through various sensors equipped on the robot R (e.g., a camera (an image sensor), a proximity sensor, an infrared sensor, etc., but example embodiments are not limited thereto).

In some example embodiments, the robot R traveling in the building 1000 through processes of (a), (b), and (c) of FIG. 1 may be configured to provide services to humans U or target objects present in the building 1000, as illustrated in (d) of FIG. 1.

According to some example embodiments, the types of services provided by the robot R may vary from one robot R to another. For example, there may be different types of robots R for different purposes, and the robots R may have different structures for different purposes, and the robots R may be equipped with a program that is appropriate for the purpose.

For example, the building 1000 may be arranged with robots R that provide at least one of delivery, logistics operations, guidance, interpretation, parking, security, crime prevention, guarding, policing, cleaning, sanitizing, disinfecting, laundry, food preparation, serving, fire suppression, medical assistance, and entertainment services, but example embodiments are not limited thereto. For example, the services provided by the robots R may vary in addition to the examples listed above.

In some example embodiments, the cloud server 20 may assign appropriate missions to the robots R, taking into account respective uses of the robots R, and perform control of the robots R so that the assigned missions are carried out.

At least some of the robots R described in some example embodiments of the present inventive concepts may travel or perform missions under control of the cloud server 20, in which case the amount of data processed by the robots R themselves to travel or perform missions may be minimized. According to some example embodiments, such a robot R may be referred to as a brainless robot. For example, the brainless robot may rely on control of the cloud server 20 for at least some of the control in carrying out activities such as traveling, performing tasks, charging, standby, cleaning, etc., within the building 1000.

However, in the present specification, the brainless robots are not named separately, and all robots are referred to as “robots”.

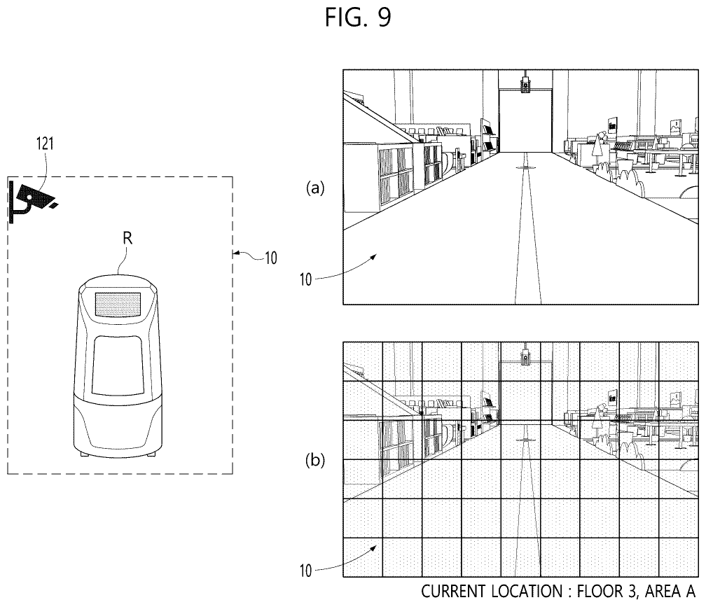

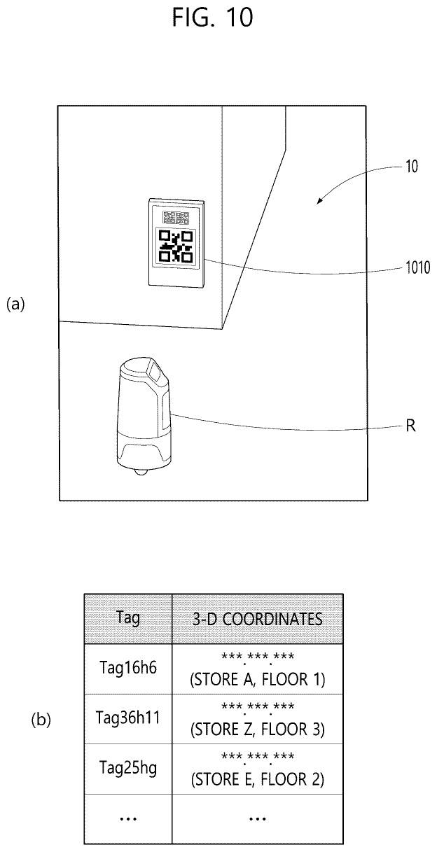

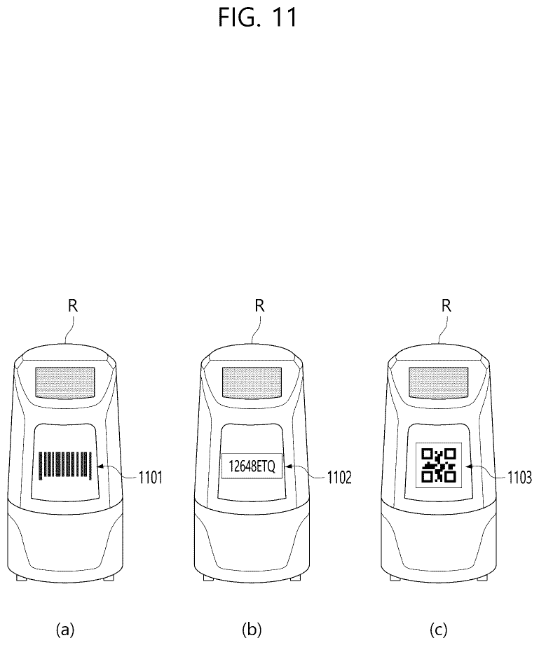

FIGS. 9 to 11 are conceptual views for describing a method of estimating a position of a robot traveling in the robot-friendly building according to some example embodiments of the present inventive concepts.

As described above, in the building 1000 according to some example embodiments of the present inventive concepts, it is possible to extract and monitor locations of the robots R using various infrastructures provided in the building 1000. According to some example embodiments, the cloud server 20 may perform efficient and accurate control of the robots R within the building 1000 by monitoring the locations of the robots R.

According to some example embodiments, in order to provide various services using the robot R, it is very important, or alternatively desirable or advantageous to quickly and intuitively monitor an operational situation of a plurality of robots R located in the building 1000.

Accordingly, some example embodiments of the present inventive concepts propose a method of providing a user interface for monitoring, at a glance, a large amount of information on the plurality of robots R providing services in the building 1000 and the facility infrastructures 200 used by the plurality of robots R (see FIG. 14).

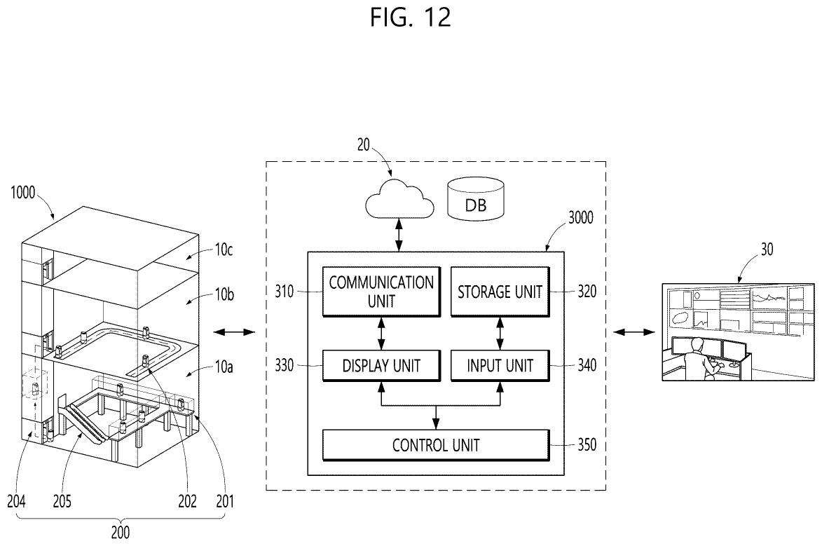

FIG. 12 is a conceptual view describing a system for monitoring an operational situation of a robot R according to some example embodiments of the present inventive concepts.

As illustrated in FIG. 12, a system 3000 for monitoring a robot operation according to some example embodiments of the present inventive concepts may receive robot information from each of a plurality of robots R disposed (e.g., located) in the building 1000, collect facility information from each of facility infrastructures 200, and provide a monitoring screen for monitoring an operational situation of the plurality of robots R or the plurality of facility infrastructures 200 located in the building 1000.

The monitoring screen provided by some example embodiments of the present inventive concepts may visualize a large amount of data as an intuitive and easily recognizable structure so that a user may monitor at a glance the operational situation of the plurality of robots R and the plurality of facility infrastructures 200 disposed on each of the plurality of floors 10a, 10b, and 10c of the building 1000 (hereinafter referred to as the “robot operational situation”).

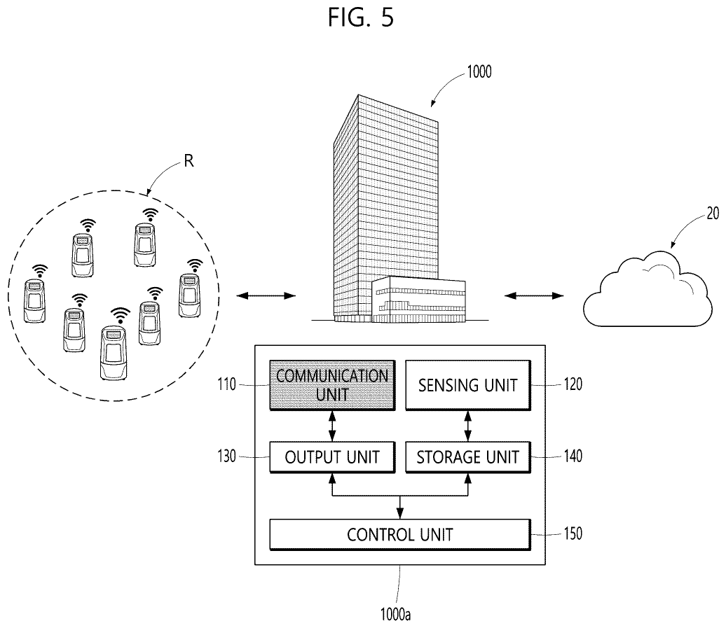

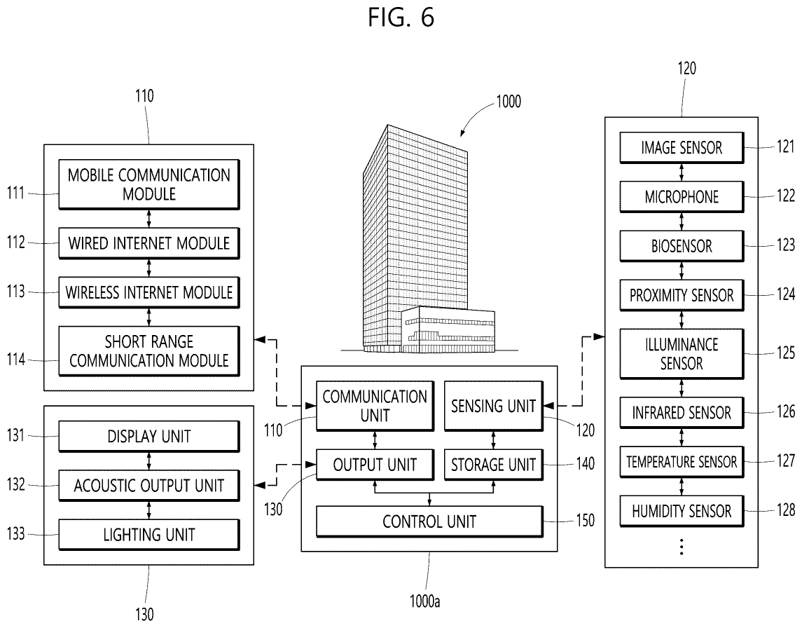

According to some example embodiments, at least some of functions performed by the system 3000 for monitoring a robot operation according to the present inventive concepts may correspond to one function of the cloud server 20, or may correspond to one function of a building system 1000a (e.g., the building system 1000a illustrated in FIGS. 5 and 6). For example, referring to FIGS. 5-6, the building system 1000a may include a communication unit 110, a sensing unit 120, an output unit 130, a storage unit 140, and a control unit 150. In some example embodiments, the communication unit 110 may include a mobile communication module 111, a wired internet module 112, a wireless internet module 113, and a short range communication module 114, but example embodiments are not limited thereto. In some example embodiments, the sensing unit 120 may include an image sensor 121, a microphone 122, a biosensor 123, a proximity sensor 124, an illuminance sensor 125, an infrared sensor 126, a temperature sensor 127, and a humidity sensor 128, etc., but example embodiments are not limited thereto. In some example embodiments, the output unit 130 may include a display unit 131, an acoustic output unit 132, and a lighting unit 133.

When at least some of the functions performed by the system 3000 of monitoring a robot operation correspond to one function of the cloud server 20 or the building system 1000a, it may be understood that, in some example embodiments, the corresponding function is performed by a configuration of the cloud server 20 or the building system 1000a.

For example, it may be understood that a function of receiving robot information from each of the plurality of robots R disposed within the building 1000, by a communication unit 310 of the system 3000 for monitoring a robot operation, is performed by the cloud server 20 or one configuration of the building system 1000a.

In some example embodiments, the system 3000 for monitoring the robot R operation according to the present inventive concepts may be configured separately from the cloud server 20 and the building system 1000a.

For example, the system 3000 for monitoring the robot R operation according to the present inventive concepts may perform communication with at least one of the cloud server 20 and the building system 1000a, or use information stored in at least one of the server 20 and the building system 1000a, in order to provide a monitoring screen for the robot R operational situation.

According to some example embodiments of the present inventive concepts, as illustrated in FIG. 12, the system 3000 for monitoring the robot R operation may include at least one of a communication unit 310, a storage unit 320, a display unit 330, an input unit 340, and a control unit 350, but example embodiments are not limited thereto. As described herein, the communication unit 310, the storage unit 320, the display unit 330, the input unit 340, and the control unit 350, and/or portions thereof according to any of the example embodiments may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of the communication unit 310, the storage unit 320, the display unit 330, the input unit 340, and the control unit 350, and/or portions thereof according to any of the example embodiments.

According to some example embodiments, the communication unit 310 may be configured to communicate with at least one of: i) various robots R disposed within the building 1000, ii) various facility infrastructures 200 disposed within the building 1000, iii) the cloud server 20, and iv) the building system 1000a.

The communication unit 310 may receive robot information from each of the plurality of the robots R disposed within the building 1000. In some example embodiments, the communication unit 310 may receive robot information for each of the plurality of the robots R disposed within the building 1000 from the cloud server 20.

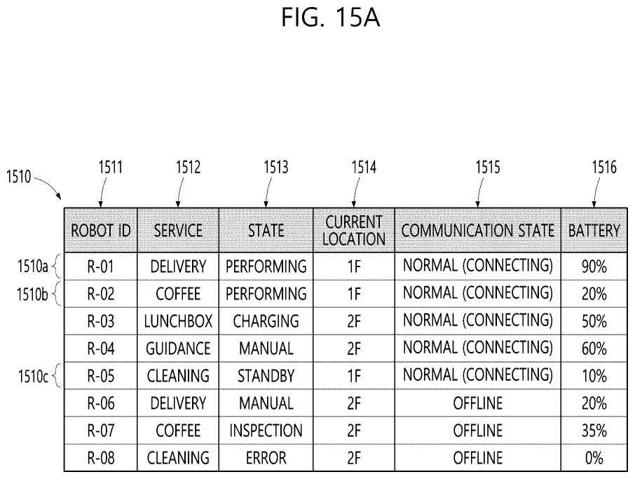

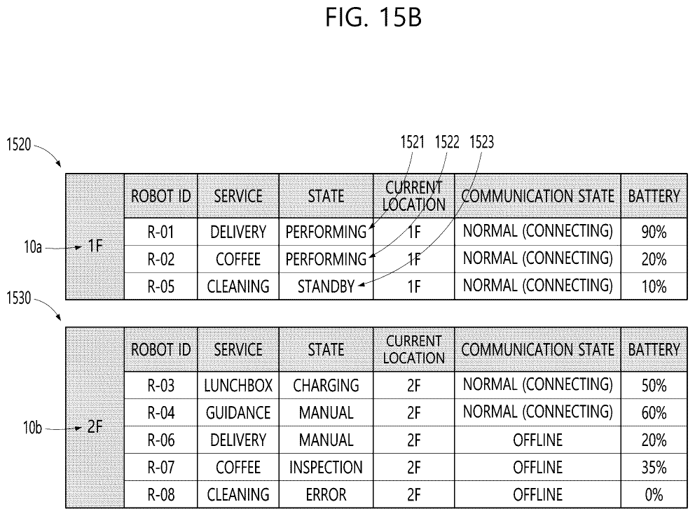

Here, according to some example embodiments, “robot information” may include various information to identify the operational situation of each robot R. For example, as illustrated in FIG. 15A, robot information 1510 may include at least one of i) identification information 1511 (e.g., ROBOT ID) on the robot R that transmitted, provided, or sent the robot information (e.g., ID, serial number, etc.), ii) information 1512 on a mission (e.g., SERVICE) assigned to the robot R, iii) state information 1513 on the robot R, vi) location information 1514, e.g., current location information, on the robot R, v) information 1515 related to a communication state on the robot R, and vi) information 1516 related to a battery on the robot R.

In some example embodiments, the communication unit 310 may collect facility information for each of the plurality of facility infrastructures 200 disposed within the building 1000. The communication unit 310 may receive facility information on each of the facility infrastructures from facility control systems 201a, 202a, 203a, 204a, and so on (e.g., facility control systems 201a, 202a, 203a, 204a, etc., illustrated in FIG. 4). In some example embodiments, the communication unit 310 may receive facility information for each of the facility infrastructures from the building system 1000a.

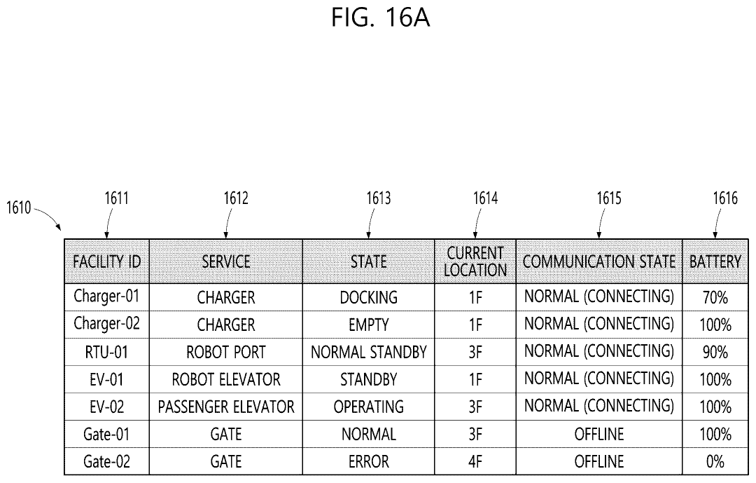

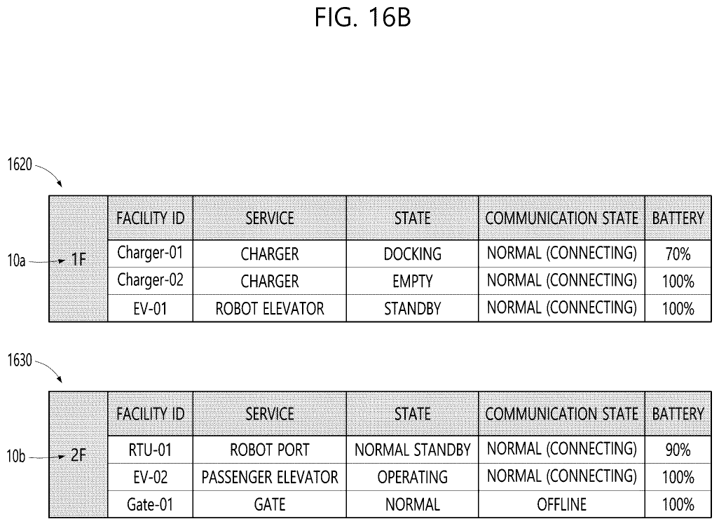

According to some example embodiments, “facility information” may include various information to identify the operational situation of each facility infrastructure 200. For example, as illustrated in FIG. 16A, “facility information” 1610 may include i) identification information (e.g., ID, serial number, facility ID, etc., 1611) that identifies the facility infrastructure 200, ii) information 1612 on a function, service or type of the facility infrastructure 200, iii) state information 1613 on the facility infrastructure 200, vi) location information 1614, e.g., current location information, on the facility infrastructure 200, v) information 1615 related to a communication state of the facility infrastructure 200, and vi) information 1616 related to a battery of the facility infrastructure 200.

Referring back to, e.g., FIG. 12, in some example embodiments, the storage unit 320 may be configured to store various information related to the present inventive concepts. According to some example embodiments of the present inventive concepts, the storage unit 320 may be provided in the system 3000 for monitoring the robot R operational situation itself, but example embodiments are not limited thereto. In some example embodiments, at least a portion of the storage unit 320 may mean or refer to at least one of the cloud server 20, an external database, and a storage unit 140 of the building system 1000a. For example, it can be understood that the storage unit 320 is sufficient to be a space in which information necessary, desirable, or alternatively advantageous for providing the monitoring screen according to the present inventive concepts is stored, and there are no restrictions on a physical space. For example, it can be understood that the storage unit 320 may be or may refer to a space in which information utilized for the monitoring screen may be stored. Accordingly, hereinafter, the storage unit 320, the cloud server 20, the external database DB, and the storage unit 140 of the building system 1000a will all be referred to as the storage unit 320, without distinguishing separately. According to some example embodiments of the present inventive concepts, any of the memories described herein, including, without limitation, the storage unit 320, the cloud server 21, the external database DB, and the storage unit 140 of the building system 1000a may be a non-transitory computer readable medium and may store a program of instructions. Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

In some example embodiments, the storage unit 320 may be configured to store at least a portion of the robot information 1510 and the facility information 1610.

As illustrated in FIG. 15A, the storage unit 320 may have a plurality of robot information 1510 received from each of the plurality of the robots R located in the building 1000.

In some example embodiments, as illustrated in FIG. 15B, the storage unit 320 may have a plurality of robot data sets 1520 and 1530 in which the robot information 1510 is grouped based on the plurality of floors 10a, 10b, and 10c within the building 1000.

The robot data set 1520 grouped into a first group may include robot information on the robot R located on a first specific floor (e.g., 1F, 10a) of the plurality of floors 10a, 10b, and 10c in the building 1000.

The robot data set 1530 grouped into a second group may include robot information on the robot R that is located on a second specific floor (e.g., 2F, 10b) of the plurality of floors 10a, 10b, and 10c in the building 1000 that is different from the first specific floor (e.g., 1F, 10a).

According to some example embodiments, as illustrated in FIG. 16A, the storage unit 320 may have the facility information 1610 on the plurality of facility infrastructures 200 located in the building 1000.

In some example embodiments, as illustrated in FIG. 16B, the storage unit 320 may have a plurality of facility data sets 1620 and 1630 in which the facility information is grouped based on the plurality of floors 10a, 10b, and 10c within the building 1000.

The facility data set 1620 grouped into the first group may include facility information on the facility infrastructure 200 located on the first specific floor (e.g., 1F, 10a) of the plurality of floors 10a, 10b, and 10c in the building 1000.

The robot data set 1630 grouped into the second group may include facility information on the facility infrastructure that is located on the second specific floor (2F, 10b) of the plurality of floors 10a, 10b, and 10c in the building 1000 that is different from the first specific floor (e.g., 1F, 10a).

Referring back to, e.g., FIG. 12, in some example embodiments, the display unit 330 may be configured to output a monitoring screen for monitoring the operational situation of the plurality of robots R disposed within the building 1000. The display unit 330 is provided on a device of an administrator who remotely manages the robot R, and may be provided in a remote control room 30, e.g., as illustrated in FIG. 12, but example embodiments are not limited thereto. For example, in some example embodiments, the display unit 330 may be a display provided on a mobile device. As described above, example embodiments of the present inventive concepts is not limited to different types of the display unit.

According to some example embodiments, the input unit 340 is for inputting information from a user (or an administrator), and the input unit 340 may be a medium between a user (or an administrator) and the system 3000 for monitoring the robot R operational situation. For example, the input unit 340 may mean an input means for receiving information related to the system for monitoring the robot R operational situation from a user.

For example, there is no specific limitation on the type of input unit 340, and the input unit 340 may include, but is not limited to, at least one of a mechanical input means (or a mechanical key, e.g., a mouse, a joystick, a physical button, a dome switch, a jog wheel, a jog switch, etc.) and a touch input means. According to some example embodiments, the touch input means may include virtual keys, soft keys, or visual keys that are displayed on a touchscreen through software processing, or touch keys that are disposed on a portion other than the touchscreen.

According to some example embodiments, the virtual or visual keys may be displayed on the touchscreen in a variety of forms, and may be configured to be, for example, a graphic, a text, an icon, a video, or a combination thereof. For example, when the input unit 340 includes a touchscreen, the display unit 330 may be configured as the touchscreen. For example, the display unit 330 may perform or be configured to perform both a role of outputting information and a role of receiving information (e.g. input information).

According to some example embodiments, the control unit 350 may be configured to control an overall operation of the system 3000 for monitoring the robot R operational situation associated with the present inventive concepts. The control unit 350 may process signals, data, information, and the like that are input or output through the constituent elements (e.g., communication unit 310, storage unit 320, display unit 330, input unit 340, control unit 1000a, etc.) described above, or may provide or process appropriate information or functions to a user.

In some example embodiments, the control unit 350 may provide a monitoring screen for monitoring the operational situation of the robot R in the building 1000 at a glance using at least some of the robot information 1510 received from each of the plurality of the robots R disposed in the building 1000 and the facility information 1610 collected from the plurality of facility infrastructure 200.

The control unit 350 may process (e.g., sort, extract, or categorize, etc.) the plurality of robot information 1510 (see, e.g., FIG. 15A) and the plurality of facility information 1610 (see, e.g., FIG. 16A) according to predetermined, or alternatively desired standards to generate and provide a monitoring screen that allows a user to intuitively recognize the operational situations of the robots R and the facility infrastructures 200 in the building 1000 at a glance.

In some example embodiments, the control unit 350 may use some of the plurality of robot data sets 1520 and 1530 grouped based on a specific floor as illustrated in FIG. 15B and the plurality of facility data sets 1620 and 1630 grouped based on a specific floor as illustrated in FIG. 16B to generate and provide a monitoring screen that allows a user to recognize the operational situation of the robot R in the building 1000 at a glance.

The control unit 350 may match (or link) the received plurality of robot information 1510 and plurality of facility information 1610 to a specific floor of the plurality of floors 10a, 10b, and 10c in the building 1000 and store the received plurality of robot information 1510 and plurality of facility information 1610 in the storage unit 320 to generate the robot data sets 1520 and 1530 (see, e.g., FIG. 15B) or the facility data sets 1620 and 1630 (see, e.g., FIG. 16B) that are grouped based on a specific floor.

As described above, according to some example embodiments of the present inventive concepts, the control unit 350 may allow graphic objects (e.g., graphical objects) corresponding to operational current situation information on the robots R or facility infrastructures 200 (e.g., information related to the number of the robots R or facilities, location information, operational state information, information on problem situations that have occurred, timeline information, information on current linkage situations between the robots R and facility infrastructures 200, etc.) disposed in the building 1000 to be included on the monitoring screen to enable a user to intuitively recognize the operational situations of the robots R.

According to some example embodiments, the control unit 350 may be referred to as the cloud server 20 or a server, in which case it is of course possible for the cloud server 20 or the server to perform the role of the control unit 350.

Hereinafter, a method of providing a monitoring screen through which the operational situations of the robots R in the building 1000 may be intuitively and quickly monitored based on the robot information 1510 received from the robots R and the facility information 1610 collected from the facility infrastructures, according to some example embodiments of the present inventive concepts, will be described in more detail with reference to the accompanying drawings.

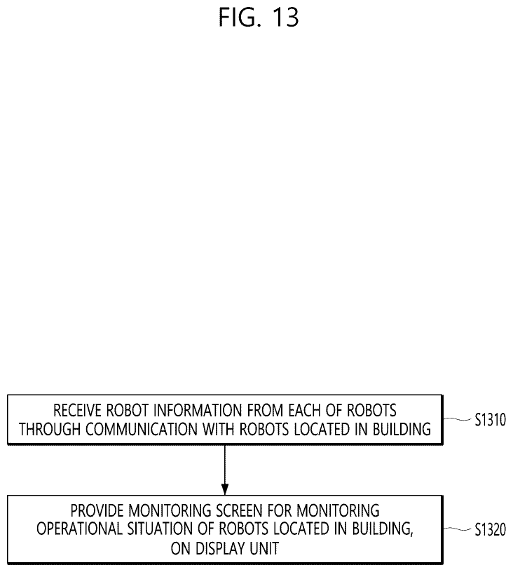

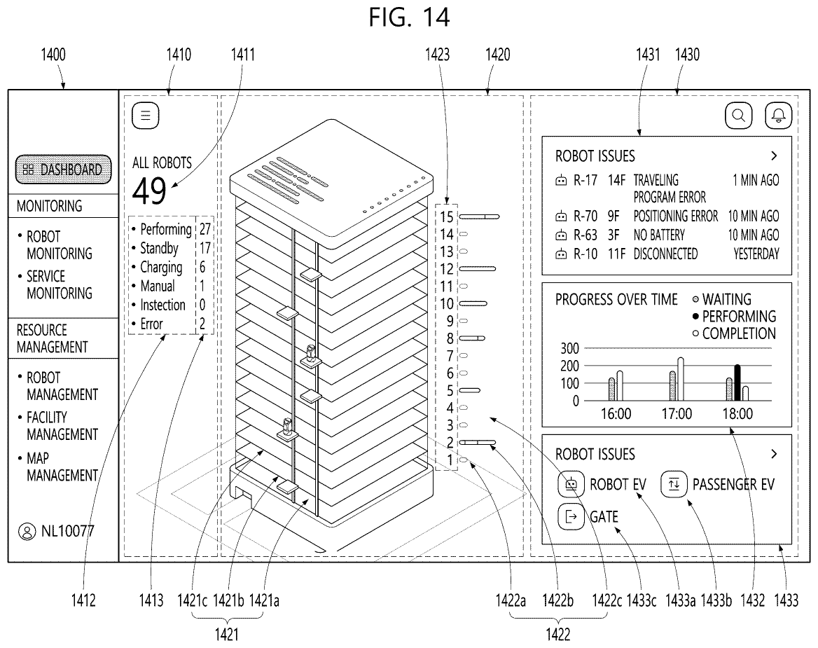

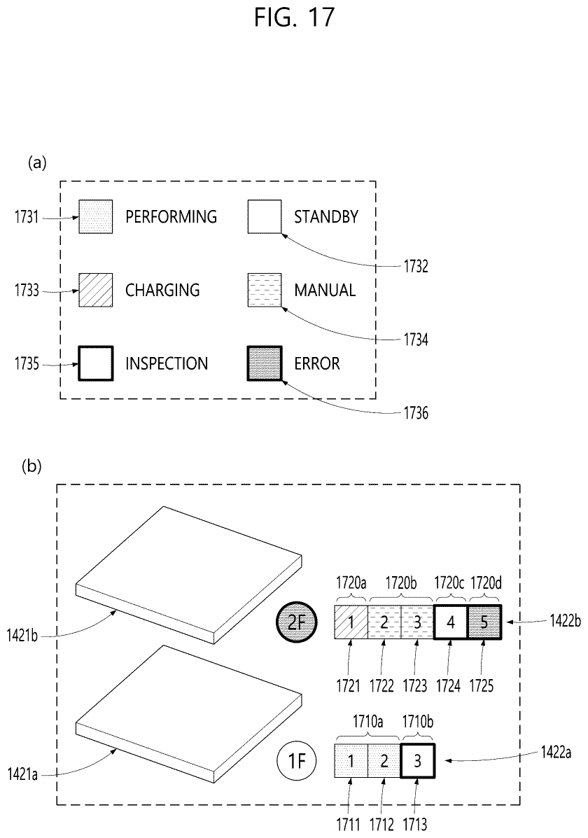

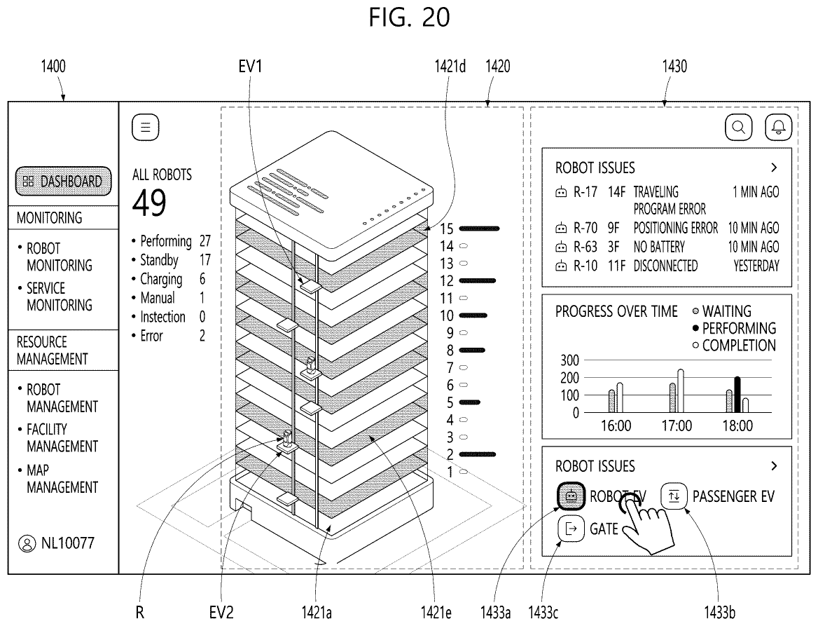

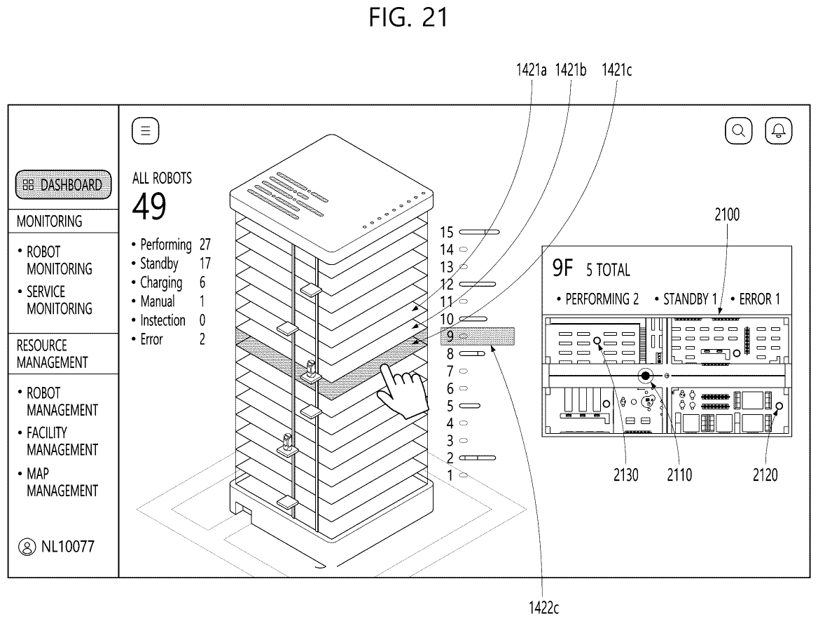

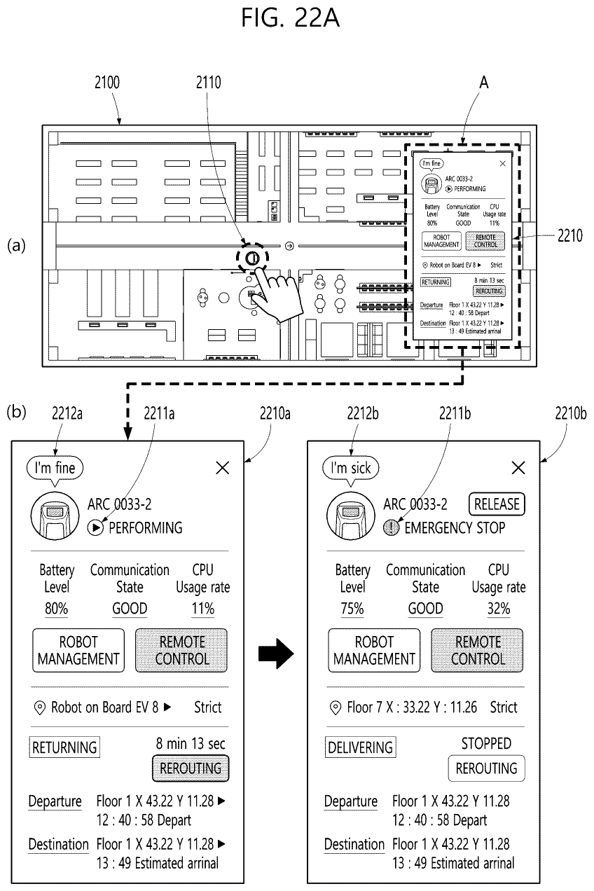

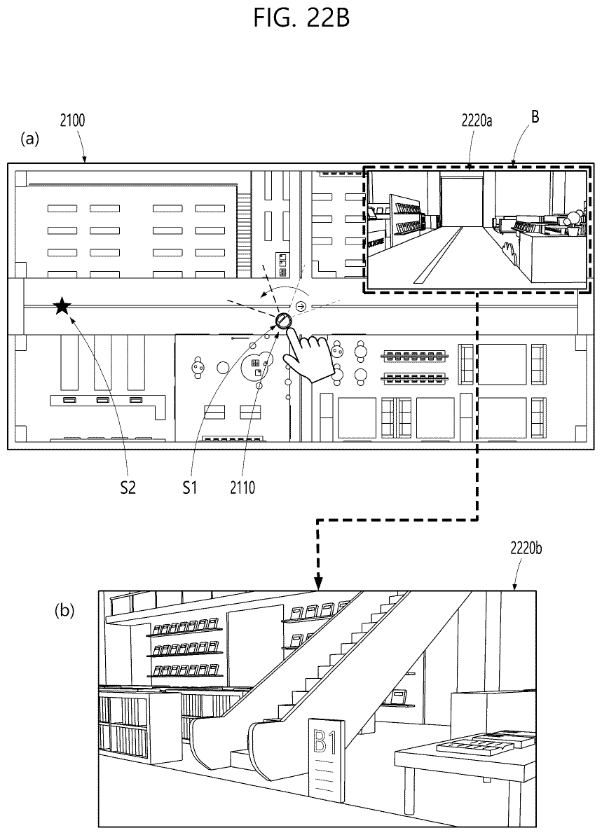

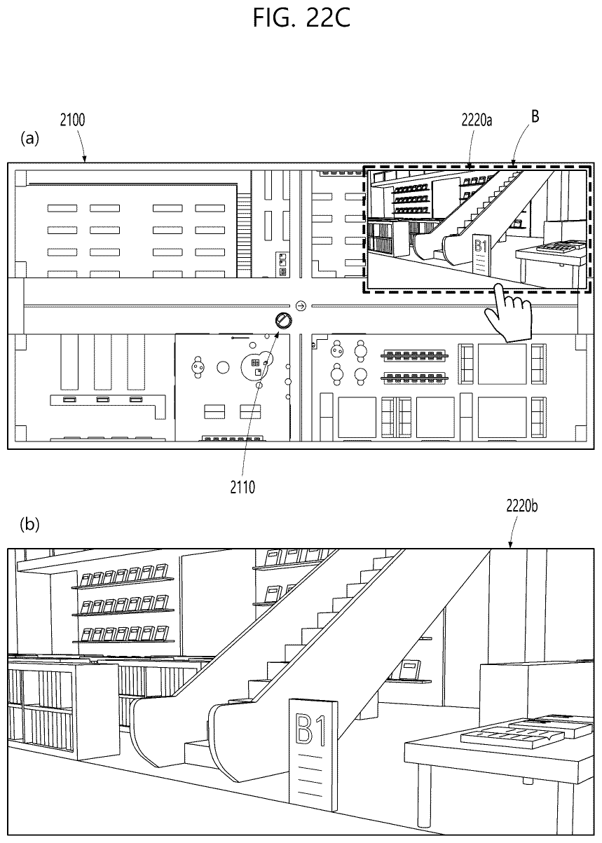

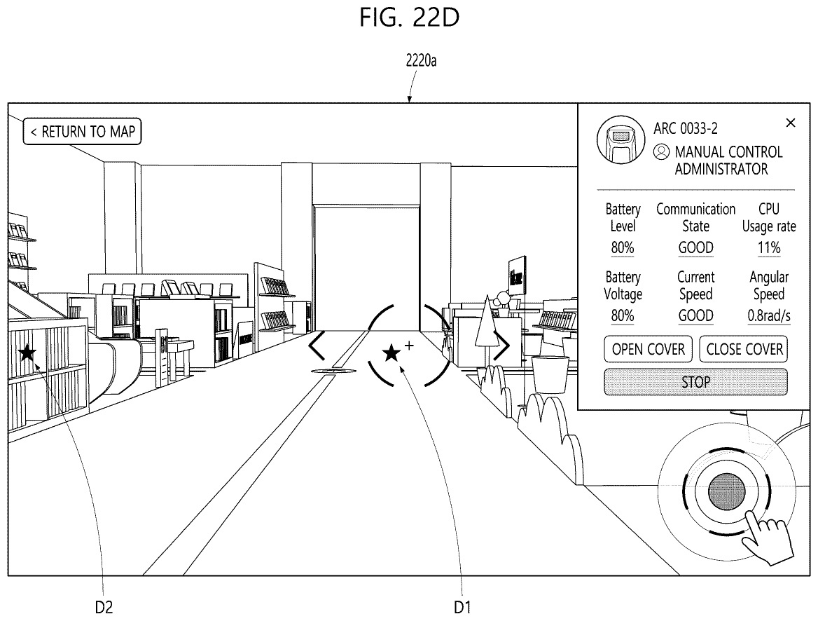

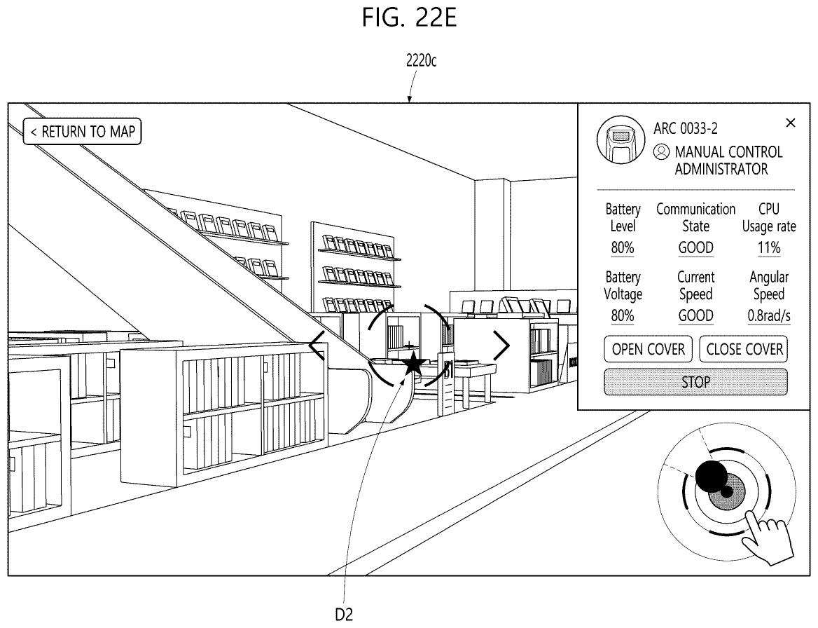

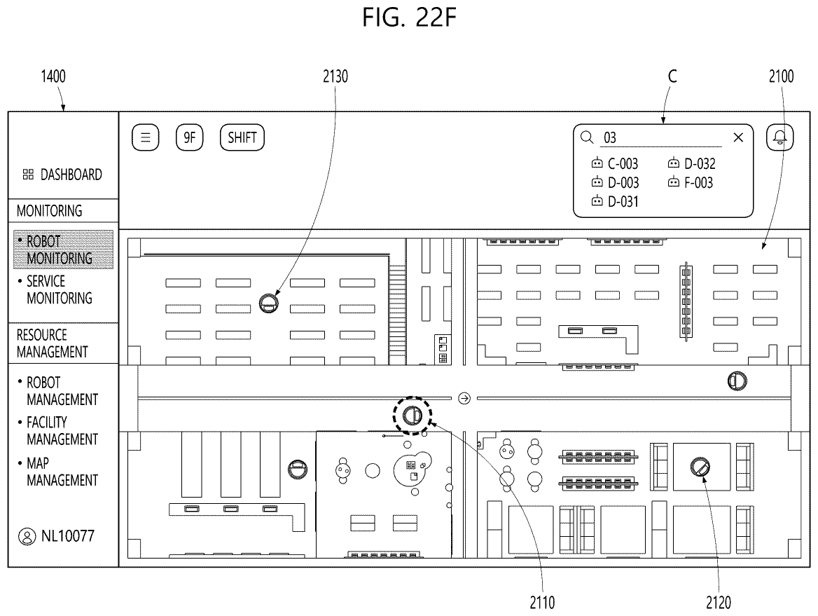

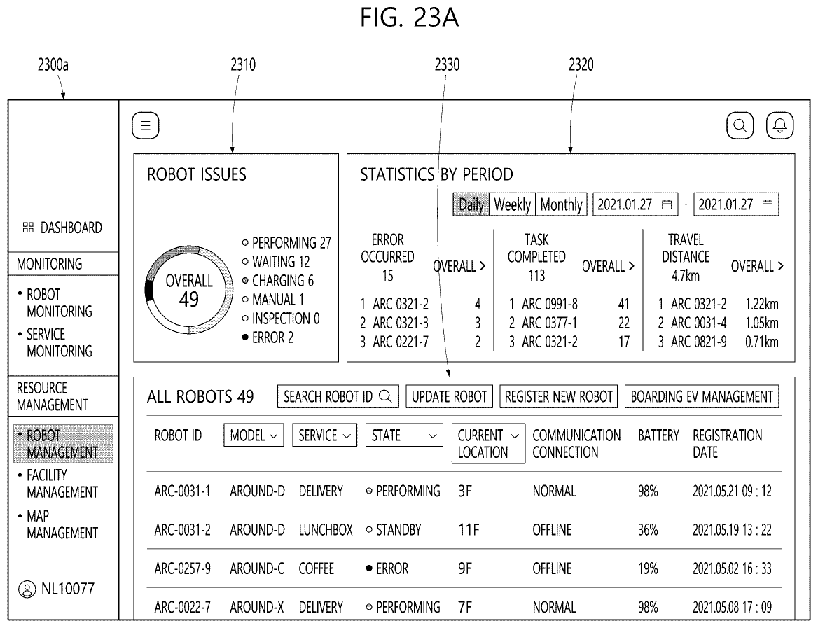

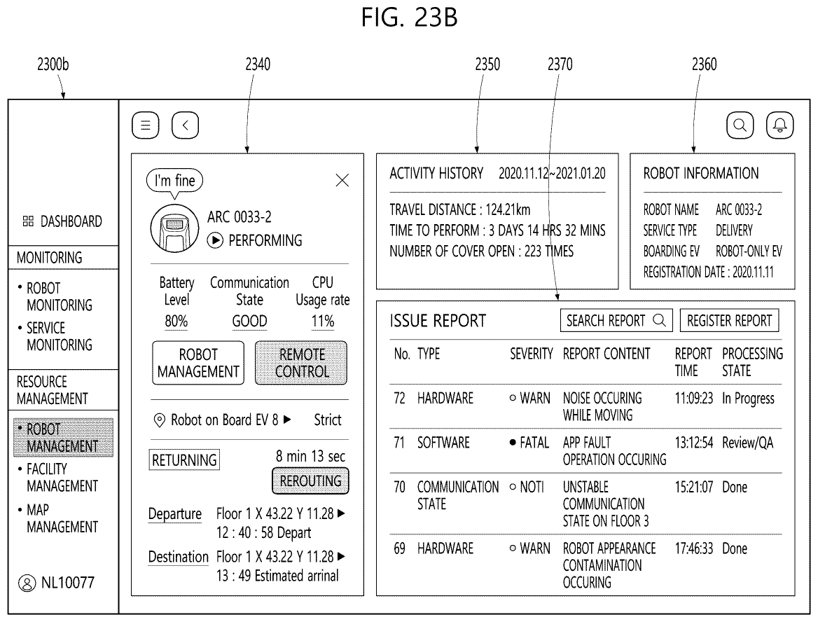

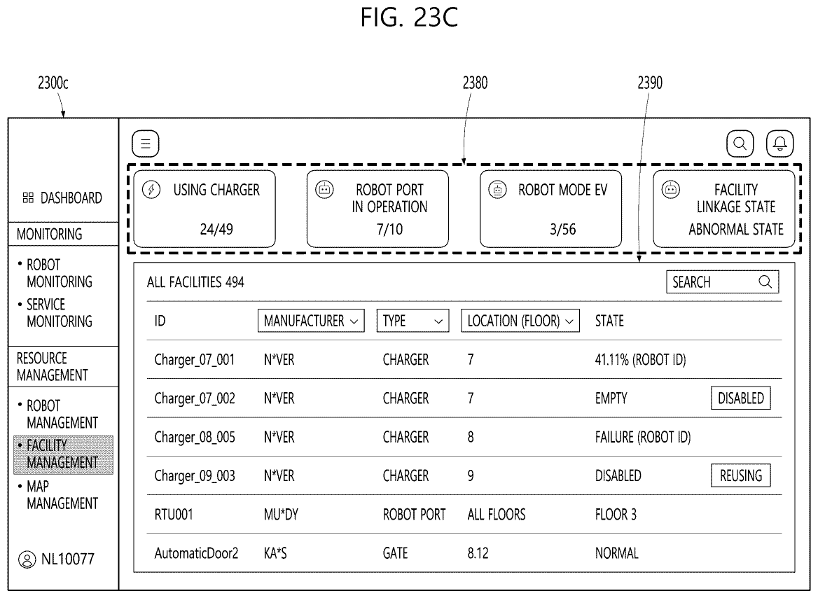

FIG. 13 is a flowchart describing a method of monitoring a robot R operation according to some example embodiments of the present inventive concepts. FIG. 14 is a conceptual view for describing a monitoring screen according to some example embodiments of the present inventive concepts, FIG. 15A is a conceptual view for describing robot information according to some example embodiments of the present inventive concepts, FIG. 15B is a conceptual view for describing a plurality of robot datasets grouped by floors according to some example embodiments of the present inventive concepts, FIG. 16A is a conceptual view for describing facility information according to some example embodiments of the present inventive concepts, FIG. 16B is a conceptual view for describing a plurality of facility datasets grouped by floors according to some example embodiments of the present inventive concepts, FIGS. 17, 18, and 19 are conceptual views for describing a state graphic object representing state information on a robot R located on each of a plurality of floors included in a building according to some example embodiments of the present inventive concepts, FIG. 20 is a conceptual view for describing a monitoring screen that provides operational situation information on robots based on types of robots and facilities according to some example embodiments of the present inventive concepts, FIG. 21, FIG. 22A, FIG. 22B, FIG. 22C, FIG. 22D, FIG. 22E, and FIG. 22F are conceptual views for describing a monitoring screen that provides operational situation information on robots based on a particular floor according to some example embodiments of the present inventive concepts, and FIGS. 23A, 23B, and 23C are conceptual views for describing a user interface for monitoring an operational situation of a robot according to some example embodiments of the present inventive concepts.

According to some example embodiments, a process of receiving robot information from each of the robots R may proceed through communication with the robots R located in the specific building 1000 where the robots R provide services (S1310, see, e.g., FIG. 13). For example, referring to FIG. 13, at operation S1310, the communication unit 310 may receive robot R information from each of the robots R through communication with the robots R located in the building 1000.

For example, the communication unit 310 may receive first robot information from a first robot R that provides a service and is located in the specific building 1000, and may receive second robot information from a second robot R that is different from the first robot R.

But example embodiments are not limited thereto, and, for example, situations in which the communication unit 310 receives robot information from each of a plurality of the robots R located in the building 1000 may vary.

In some example embodiments, the communication unit 310 may receive the first robot information from the first robot R based on a change in a state of the first robot R (e.g., a change from a state of performing a mission to a state of standby).

In some example embodiments, the communication unit 310 may receive the second robot information from the second robot R based on a change in a location of the second robot R.

As described above, in some example embodiments, the robot information may include a variety of information to identify an operational situation for each of the robots R. For example, as illustrated in FIG. 15A, robot information 1510 may include at least one of i) identification information 1511 on the robot R that transmitted, provided, or sent robot information (e.g., ID, serial number, robot ID, etc.), ii) information 1512 on a mission (e.g., service) assigned to the robot R, iii) state information 1513 on the robot R, vi) location information 1514 (e.g., current location information) on the robot R, v) information 1515 related to a communication state on the robot R, and vi) information 1516 related to a battery on the robot R.

According to some example embodiments, the process may proceed to provide, on the display unit 330, a monitoring screen for monitoring operational situations of the robots R located in the specific building 1000 where the robots R provide services (S1320, see, e.g., FIG. 13). For example, referring to FIG. 13, in some example embodiments, at operation S1320, the control unit 350 may provide a monitoring screen for monitoring the operational situation of the robots R located in the building 1000 on the display unit 330.

For example, the control unit 350 may process the robot information according to predetermined, or alternatively desired standards so that a user may quickly and intuitively recognize state information on the robots R located on each of the plurality of floors 10a, 10b, and 10c constituting the building 1000 through the monitoring screen, and control such that graphic objects that are processed and correspond to the standards are included on the monitoring screen.

As illustrated in FIG. 14, a monitoring screen 1400 may include at least one area of a first area 1410, a second area 1420, and a third area 1430.

The control unit 350 may control the monitoring screen 1400 such that each of the first area 1410, second area 1420, and third area 1430 of the monitoring screen 1400 includes different information (or graphic objects) related to operational situations of the robots R in the building 1000.

Hereinafter, information (or graphic objects) related to operational situations of the robots provided through each of the first area 1410, second area 1420, and third area 1430 of the monitoring screen 1400 and data processing thereof will be described according to some example embodiments of the present inventive concepts.

First, as illustrated in FIG. 14, the first area 1410 may include overall operational current situation graphic objects 1411, 1412, and 1413 that represent overall operational current situation information for all of the plurality of the robots R located within the building 1000, based on a plurality of robot information 1510 received from each of the plurality of the robots R located in the building 1000.

The overall operational current situation graphic objects 1411, 1412, and 1413 may include at least one of i) a first overall operational current situation graphic object representing the number of all of the plurality of the robots R located in the building 1000 (e.g., “all robots 49”, 1411), ii) a plurality of second overall operational current situation graphic objects 1412, each having a different visual appearance corresponding to a different operational state; and iii) a plurality of third overall operational current situation graphic objects 1413 representing the number of the robots R corresponding to the specific operational state.

The plurality of second overall operational current situation graphic objects 1412 may each have a different visual appearance, such that different operational states of the robot R corresponding to each of the graphic objects 1412 are distinguishable.

For example, the second overall operational current situation graphic object corresponding to a first operational state (e.g., “performing” in 1412) and the second overall operational current situation graphic object corresponding to a second operational state (e.g., “standby” in 1412) may be represented by different colors.

According to some example embodiments, the information related to the visual appearance corresponding to each of different operational states of the robot R may be preset and exist in the storage unit 320.

The information related to the visual appearance (e.g., corresponding to the graphic objects 1412) existing in the storage unit 320 may include a first visual appearance corresponding to a first operational state (e.g., “performing”), a second visual appearance corresponding to a second operational state (e.g., “standby”), a third visual appearance corresponding to a third operational state (e.g., “charging”), a fourth visual appearance corresponding to a fourth operational state (e.g., “manual”), a fifth visual appearance corresponding to a fifth operational state (e.g., “inspection”), and a sixth visual appearance corresponding to a sixth operational state (e.g., “error”).

In some example embodiments, each of the plurality of third overall operational current situation graphic objects 1413 may be represented on the first area 1410 by being matched with each of the second overall operational current situation graphic objects 1412 corresponding to a specific operation.

For example, a third graphic object corresponding to a “standby” operation (e.g., “29”) may be matched with a second graphic object corresponding to a “standby” operation and represented on the first area 1410. In some example embodiments, the third graphic object corresponding to a “performing” operation (e.g., “17”) may be matched to the second graphic object corresponding to a “performing” operation and represented on the first area 1410.

Accordingly, in some example embodiments of the present inventive concepts, a user may intuitively and quickly identify at a glance the total number of the robots R disposed in the building 1000, and the number of the robots R corresponding to each of the operational states, simply by viewing the first area 1410 of the monitoring screen 1400.

In some example embodiments, the control unit 350 may generate an overall operational current situation information on the robots R by processing the robot information 1510 (e.g., illustrated in FIG. 15A) received from the plurality of the robots R according to predetermined, or alternatively desired standards (or a predetermined, or alternatively desired first standard) so that the graphic objects 1411, 1412, and 1413 representing the overall operational current situation for the robots operating in the building 1000 are included (or output) on the first area 1410.

In some example embodiments, the control unit 350 may generate overall quantity information on the robots R located in the building 1000 by summing up the overall number (or quantity) of the plurality of the robots R according to predetermined, or alternatively desired standards. In some example embodiments, the control unit 350 may generate overall quantity information of the robots R for each operational state of different robots R among the plurality of robots R, according to predetermined, or alternatively desired standards.

The control unit 350 may generate quantity information on all the robots R corresponding to a specific operational state in the robot information 1510 by counting the number (or count) of the robots R including operational state information corresponding to the specific operational state. For example, the control unit 350 may generate information (e.g., “19”) on the total number of robots R corresponding to the operational state of the first operation (e.g., “performing”) in the robot information 1510 by counting the number of the robots R that includes the state information on the first operation (e.g., “performing”).

According to some example embodiments of the present inventive concepts, it is also possible that the information on the total number of robots R located in the building 1000 is pre-registered in a system.

The control unit 350 may change the overall operational current situation graphic objects 1411, 1412, and 1413 included in the first area 1410 based on the overall operational current situation information on the robot R being changed. For example, when the total number of the robots R providing services in the building 1000, or the number of robots R corresponding to a specific operational state changes, the control unit 350 may change the overall operational current situation information on the robots R included in the monitoring screen 1400 in real time to reflect the changed situation.

According to some example embodiments, as illustrated in FIG. 14, the second area 1420 may include operational current situation graphic objects 1421, 1422, and 1423 for each floor (e.g., 10a, 10b, 10c, etc.) for representing operational current situation information on the robots R located on each of the plurality of floors 10a, 10b, and 10c constituting the building 1000.

The operational current situation graphic objects 1421, 1422, and 1423 for each floor (e.g., 10a, 10b, 10c, etc.) may include at least one of i) a building graphic object 1421 representing a specific building 1000 where the robots R provide services, ii) a state graphic object 1422 representing state information on the robots R located on each of a plurality of floors 10a, 10b, and 10c included in the building 1000, and iii) a floor guide graphic object 1423 representing information on a plurality of floors 10a, 10b, and 10c included in the building 1000.

The building graphic object 1421 may configured as a shape corresponding to a specific building 1000 where the robots R provide services. The building graphic object 1421 may be pre-stored in the storage unit 320.

The building graphic object 1421 may include a plurality of sub-graphic objects 1421a, 1421b, and 1421c mapped (or matched) to each of the plurality of floors 10a, 10b, and 10c included in the building 1000.

In some example embodiments, the building graphic object 1421 may include a first sub-graphic object 1421a mapped (or matched) to a first floor 10a of the plurality of floors 10a, 10b, and 10c included in the building 1000, and a second sub-graphic object 1421b mapped (or matched) to a second floor 10b.

The state graphic object 1422 may be positioned around the building graphic object 1421, in the second area 1420, to represent state information on the robots located on each of the plurality of floors 10a, 10b, and 10c included in the building 1000.

In some example embodiments, a first state graphic object 1422a may represent state information on the robots R located on the first floor 10a of the plurality of floors 10a, 10b, and 10c included in the building 1000, and a second state graphic object 1422b may represent state information on the robots R located on the second floor 10b.

Each of the plurality of state graphic objects 1422a and 1422b may be positioned around each of the sub-graphic objects 1421a and 1422b mapped to a floor corresponding to each of the plurality of state graphic objects. For example, the first state graphic object 1422a may be positioned around the first sub-graphic object 1421a mapped to the first floor 10a, and the second state graphic object 1422b may be positioned around the second sub-graphic object 1421b mapped to the second floor 10b.

Therefore, according to some example embodiments of the present inventive concepts, a user (or administrator) may intuitively recognize which state graphic objects 1422 represent states of the robots R located on each of the plurality of floors 10a, 10b, and 10c included in the building 1000.

In some example embodiments, each of the plurality of state graphic objects 1422a and 1422b may have a different visual appearance corresponding to state information on the robots R located on each of the floors 10a and 10b, based on robot information on the robots R located on the floors 10a and 10b corresponding to each of the plurality of state graphic objects 1422a and 1422b.

For example, each of the plurality of state graphic objects 1422a and 1422b may be represented by a size (or length) corresponding to the number of robots R located on the corresponding respective floors 10a and 10b.

As illustrated in (b) of FIG. 17, in some example embodiments, the state graphic objects 1422a and 1422b corresponding to a specific floor (e.g., floor 1 (1F) and floor 2 (2F), 10a and 10b) may include as many sub-state graphic objects 1711 to 1713, and 1721 to 1725 as a number corresponding to the number of robots R located on the specific floor.

The first state graphic object 1422a corresponding to the first floor 10a may include three sub-state graphic objects 1711, 1712, and 1713 corresponding to “three” robots R located on the first floor 10a.

In some example embodiments, the second state graphic object 1422b corresponding to the second floor 10b may include “five” sub-state graphic objects 1721, 1722, 1723, 1724, and 1725 corresponding to “five” robots R located on the second floor 10b.

For example, a size (or a length, or the number of sub-state graphic objects each includes) of each of the first state graphic object 1422a and the second state graphic object 1422b may be determined in proportion to the number of robots located on a specific floor (the first floor (1F) and the second floor (2F), 10a and 10b) corresponding to each of the first state graphic object 1422a and the second state graphic object 1422b.

According to some example embodiments, each of the first state graphic object 1422a and the second state graphic object 1422b may have at least one of a color, pattern, shape, form, or pattern (hereinafter referred to as a “visual appearance”) represented differently depending on the operational state of the robots located on each of the first floor 10a and the second floor 10b.

Each of the plurality of sub-graphic objects 1711, 1712, and 1713 included in the first state graphic object 1422a corresponding to the first floor 10a may be represented by a visual appearance corresponding to an operational state of each of the robots R located on the first floor 10a.

For example, as illustrated in FIG. 17, the first sub-state graphic object 1711 of the plurality of sub-state graphic objects 1711, 1712, and 1713 corresponding to the first floor 10a may be represented as a visual appearance corresponding to an operational state (e.g., “performing”) of a first robot R1 located on the first floor 10a. In some example embodiments, the second sub-state graphic object 1712 may be represented by a visual appearance corresponding to an operational state (e.g., “performing”) of a second robot R2 located on the first floor 10a, and the third sub-state graphic object 1713 may be represented by a visual appearance corresponding to an operational state (e.g., “standby”) of a third robot R3 located on the first floor 10a.

In some example embodiments, each of the plurality of sub-state graphic objects 1721, 1722, 1723, 1724, and 1725 included in the second state graphic object 1422b corresponding to the second floor 10b may be represented by a visual appearance corresponding to an operational state of each of the robots R located on the second floor 10b.

For example, as illustrated in FIG. 17, a first sub-state graphic object 1721 of the plurality of sub-state graphic objects 1721, 1722, 1723, 1724, and 1725 corresponding to the second floor 10b may be represented as a visual appearance corresponding to an operational state (e.g., “charging”) of a first robot R1 located on the second floor 10b. In some example embodiments, a second sub-state graphic object and a third sub-state graphic objects 1722 and 1723 may be represented by visual appearances corresponding to operational states (e.g., “manual”) of the second robot R2 and the third robot R3 located on the second floor 10b. In some example embodiments, a fourth sub-state graphic object 1724 may be represented by a visual appearance corresponding to an operational state (e.g., “inspection”) of a fourth robot R4 located on the second floor 10b, and a fifth sub-state graphic object 1725 may be represented by a visual appearance corresponding to an operational state (e.g., “error”) of a fifth robot R5 located on the second floor 10b.

For example, the state graphic objects 1422a and 1422b corresponding to a specific floor (e.g., floor 1 (1F) and floor 2 (2F), 10a and 10b) may include the sub-state graphic objects 1711 to 1713, 1721 to 1725 that have a visual appearance corresponding to an operational state of each of the robots R located on the specific floor.

According to some example embodiments, information related to a visual appearance corresponding to each of different operational states of the robot R may be preset and exist in the storage unit 320.

As illustrated in the legend (a) of FIG. 17, the information related to the visual appearance existing in the storage unit 320 may include a first visual appearance 1731 corresponding to a first operational state (e.g., “performing”), a second visual appearance 1732 corresponding to a second operational state (e.g., “standby”), a third visual appearance 1733 corresponding to a third operational state (e.g., “charging”), a fourth visual appearance 1734 corresponding to a fourth operational state (e.g., “manual”), a fifth visual appearance 1735 corresponding to a fifth operational state (e.g., “inspection”), and a sixth visual appearance 1736 corresponding to a sixth operational state (e.g., “error”).

As described above, according to some example embodiments of the present inventive concepts, the visual appearance of each of the first state graphic object 1422a and the second state graphic object 1422b may have at least one of a size (or a length) and a visual appearance (color, design, shape, geometry, form, pattern, or the like) that is represented differently, depending on the number and operational states of the robots located on each of the first floor 10a and the second floor 10b.

According to some example embodiments, a state graphic object corresponding to a specific floor may have sub-state graphic objects corresponding to the same operational state successively disposed, so that a state area corresponding to a specific operational state may be formed.

For example, as illustrated in FIG. 17, in the first state graphic object 1422a corresponding to the first floor 10a, the sub-state graphic objects 1711 and 1712 corresponding to a first operational state (e.g., “performing or moving”) may be successively disposed to form a first state area 1710a, and a second state area 1710b may be formed by the sub-state graphic object 1713 corresponding to a second operational state (e.g., “standby”).

For example, as illustrated in FIG. 17, in the second state graphic object 1422b corresponding to the second floor 10b, a third state area 1720a may be formed by one sub-state graphic object 1721 corresponding to a third operational state (e.g., “charging”), and a fourth state area 1720b may be formed by two sub-state graphic objects 1722 and 1723 corresponding to a fourth operational state (e.g., “manual”) successively disposed. In some example embodiments, in the second state graphic object 1422b, a fifth state area 1720c may be formed by one sub-state graphic object 1724 corresponding to a fifth operational state (e.g., “inspection”), and a sixth area 1720d may be formed by one sub-state graphic object 1725 corresponding to a sixth operational state (e.g., “error”).

Accordingly, in some example embodiments of the present inventive concepts, each of the plurality of state graphic objects 1422a and 1422b may be configured to include any one of a plurality of state areas 1710a, 1710b, 1720a, 1720b, 1720c, and 1720d representing different states of the robots R.

For example, the plurality of state areas 1710a, 1710b, 1720a, 1720b, 1720c, and 1720d may include at least one of the first state area 1710a corresponding to a specific first operational state of the robot R, the second state area 1710b corresponding to a specific second operational state of the robot R, and the third state area 1720a corresponding to a specific third operational state of the robot R.

The plurality of state areas 1710a, 1710b, 1720a, 1720b, 1720c, and 1720d may include at least one of the first state area 1710a corresponding to a specific first operational state of the robot R, the second state area 1710b corresponding to a specific second operational state of the robot R, and the third state area 1720a corresponding to a specific third operational state of the robot R.

In some example embodiments, a size (or a length) of each of the plurality of state areas 1710a, 1710b, 1720a, 1720b, 1720c, and 1720d may be determined depending on a state of each of the robots R located on a specific floor corresponding to a specific state graphic object that includes the plurality of state areas 1710a, 1710b, 1720a, 1720b, 1720c, and 1720d.

For example, the size (or the length) of each of the first state area 1710a, the second state area 1710b, and the third state area 1720a may be proportional to each of the number of robots R with the first state, the number of robots R with the second state, and the number of robots R with the third state among the robots located on the specific floor.

Accordingly, in some example embodiments, each of the plurality of state graphic objects according to the present inventive concepts may differently express at least one of a size (or a length) and a visual appearance (color, design, shape, geometry, form, pattern) of a state area, depending on the number and operational states of the robots R located on a specific floor corresponding to each of the state graphic objects.

Accordingly, in some example embodiments, a user may quickly and intuitively recognize, at a glance, the number of robots R located on each of the plurality of floors 10a, 10b, and 10c included in the building 1000 and the operational states of the robots R simply by viewing the second area 1420.

As described above, according to some example embodiments, the control unit 350 may intuitively represent states of robots and facilities located in the building 1000 by changing visual appearances of various graphic objects and screen areas.

As illustrated in FIG. 14, in some example embodiments, a floor guide graphic object 1423 represents information on a plurality of floors included in the building 1000, and may be positioned around the state graphic object 1422. A user may intuitively recognize, not only through the building graphic object 1421, but also through the floor guide graphic object 1423, that a specific state graphic object 1421 represents state information on the robot R located on which floor.

In some example embodiments, e.g., as illustrated in FIG. 17, the floor guide graphic object (“2F”) corresponding to a specific floor (e.g., floor 2, 10b) may be highlighted based on an operational state of at least one of robots R located on the specific floor corresponding to a specific operational state (e.g., “error”).

A user may intuitively identify whether the robot R corresponding to an error operational state is located on a specific floor by simply viewing the floor guide graphic 1433 of the second area 1420.

According to some example embodiments of the present inventive concepts, while a specific state graphic object corresponding to a specific floor is being output on the monitoring screen 1400, a user input of selecting any one of the first state area 1710a, the second state area 1710b, and the third state area 1720a included in the specific state graphic object may be received through at least one of the communication unit 310 and the input unit 340.

The control unit 350 may, based on the user input, provide a list of robots R that are located on a specific floor and has a state corresponding to one of state areas (e.g., the first state area 1710a) selected by the user input, on the monitoring screen 1400.

In some example embodiments, the control unit 350 may generate an operational current situation information on the robots R for each floor by processing the robot information 1510 (e.g., illustrated in FIG. 15A) received from the plurality of the robots R according to predetermined, or alternatively desired standards (or a predetermined, or alternatively desired second standard) so that the operational current situation graphic objects 1421, 1422, and 1423 for each floor are included (or output) on the second area 1420.

For example, the control unit 350 may identify which floor of the plurality of floors 10a, 10b, and 10c included in the building 1000 the robots R are located on, based on the robot information 1510 received from each of the plurality of the robots R.

As described above, in some example embodiments, the robot information 1510 may include a variety of information to identify an operational situation for each of the robots R. For example, as illustrated in FIG. 15A, the robot information 1510 may include at least one of i) identification information 1511 on the robot R that transmitted robot information (e.g., ID, serial number, robot ID, etc.), ii) information 1512 on a mission (e.g., service) assigned to the robot R, iii) state information 1513 on the robot R, vi) location information 1514 (e.g., current location information) on the robot R, v) information 1515 related to a communication state on the robot R, and vi) information 1516 related to a battery on the robot R.

The control unit 350 may determine a size (or a length) and a visual appearance of a state graphic object corresponding to each of the plurality of floors 10a, 10b, and 10c, based on a location of each of the robots R identified in the robot information 1510.

To this end, according to some example embodiments of the present inventive concepts, the control unit 350 may categorize operational states of the robots R with respect to each of the plurality of floors 10a, 10b, and 10c, based on predetermined, or alternatively desired standards.

The control unit 350 may, based on the robot information 1510, generate quantity information on the robots R operating in a specific operational state for each floor (e.g., floor 10a, 10b, and 10c, etc.) by counting the number of robots R that include operational state information corresponding to a specific operational state among the robots R located on each floor (e.g., floor 10a, 10b, and 10c, etc.).

For example, the control unit 350 may generate the quantity information on the robots R operating in a specific operational state for each floor (e.g., floor 10a, 10b, and 10c, etc.) by sorting or categorizing the plurality of robot information 1510 based on a specific floor and a specific operational state.

For example, as illustrated in FIG. 15B, the control unit 350 may generate the quantity information (e.g., “2”) by counting the number of robots (e.g., “R-01” and “R-02”, 1510a and 1510b) operating an operational state of “performing” 1521 and 1522 among the robots R located on the first floor 10a. In some example embodiments, the control unit 350 may generate the quantity information (e.g., “1”) by counting the number of the robots (e.g., “R-05”, 1510c) operating in an operational state of “standby” 1523 among the robots R located on the first floor 10a based on the plurality of robot information 1510.

The control unit 350 may control such that a plurality of state graphic objects corresponding to each floor are displayed (or output) on the monitoring screen 1400, corresponding to the quantity information for each operational state generated for each floor.

For example, the control unit 350 may, based on the robot information 1510, display (or output) a state graphic object corresponding to each of the plurality of floors on the monitoring screen 1400 such that state information on the robots R is represented in conjunction with a specific floor on which the plurality of robots R is respectively located among the plurality of floors 10a, 10b, and 10c.

In some example embodiments, the control unit 350 may determine a size (or a length) and a visual appearance of a state graphic object corresponding to each of the plurality of floors 10a, 10b, and 10c based on a plurality of data sets grouped with respect to the plurality of floors 10a, 10b, and 10c, as illustrated in FIG. 15B.

The control unit 350 may generate the quantity information on the robot R operating in a specific operational state on a specific floor by counting the number of robots R including operational state information corresponding to the specific operational state in a data set corresponding to the specific floor.

Accordingly, in some example embodiments of the present inventive concepts, state information on the robots R linked to the plurality of floors 10a, 10b, and 10c may be intuitively provided based on robot information (e.g., 1510a, 1510b, and 1510c) received from each of the plurality of robots R.

Accordingly, in some example embodiments, a user may quickly and intuitively recognize state information for each floor of the building 1000 through one monitoring screen 1400.

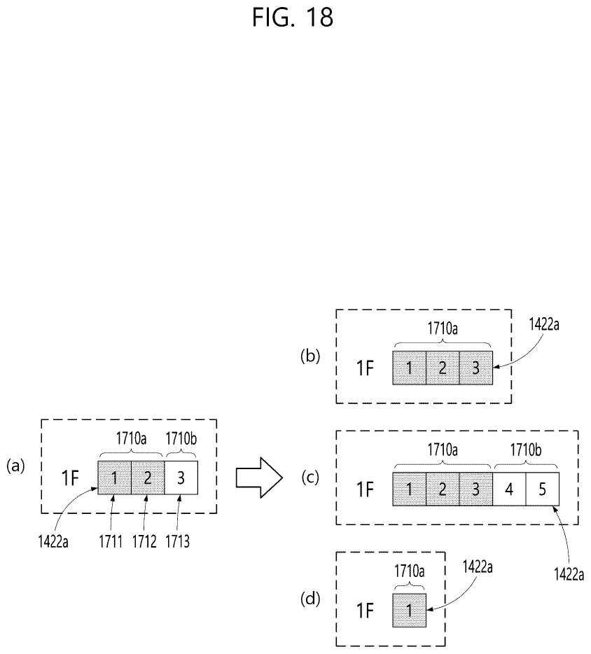

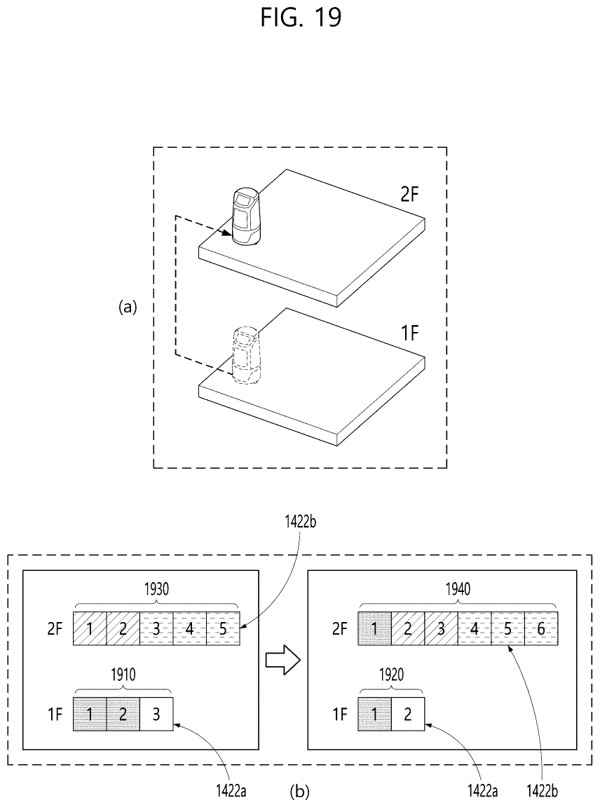

According to some example embodiments of the present inventive concepts, visual appearances of at least some of the plurality of state graphic objects may be changed based on at least one of an operational state of the robot R and a floor of the building 1000 in which the robot R is located being changed. Hereinafter, an example embodiment in which the state graphic object 1422a corresponding to a specific floor (e.g., floor 1) is configured with the first area 1710a corresponding to a first operational state and the second area 1710b corresponding to a second operational state, as illustrated in box (a) of FIG. 18, will be described as an example.

For example, the control unit 350 may, based on an operational state of at least one of robots R located on a specific floor being changed, change a visual appearance of a state graphic object corresponding to the specific floor to be in conjunction with the changed operational state of the robots R.

The control unit 350 may change a visual appearance of a state graphic object (or state area) corresponding to a specific floor on which a specific robot R is located when a change in an operation state of the specific robot R is monitored, based on specific robot information received from the specific robot R.

As illustrated in box (b) of FIG. 18, the control unit 350 may change sizes (or lengths) of the first area 1710a corresponding to the first operational state and the second area 1710b corresponding to the second operational state, while maintaining a size (or a length) of the state graphic object 1422a, based on the operational state of the specific robot R among the robots R located on the specific floor being changed from the second operational state to the first operational state.

For example, the control unit 350 may increase the size (or the length) of the first area 1710a corresponding to the first operational state to correspond to the number (e.g., “three”) of the robots R operating in the first operational state on the first floor. In some example embodiments, the size (or the length) of the second area 1710b may be decreased to correspond to the number (e.g., “0”) of the robots R operating in the second operational state on the first floor (1F).

The control unit 350 may, based on the number of robots R located in a specific floor being changed, change a size (or a length) of a state graphic object corresponding to a specific floor to correspond to the changed number of robots R.

As illustrated in box (c) of FIG. 18, when the number of the robots R located on a specific floor increase, the control unit 350 may increase a size (or a length) of the state graphic object 1422a to correspond to the increased number of the robots R. In some example embodiments, the control unit 350 may change the size (or the length) of at least one of the first state area 1710a and the second state area 1720b included in the state graphic object 1422a based on an operational state of the robot located on a specific floor.

In some example embodiments, as illustrated in box (d) of FIG. 18, when the number of the robots R located on a specific floor decrease, the control unit 350 may decrease a size (or a length) of the state graphic object 1422a to correspond to the decreased number of the robots R. In some example embodiments, the control unit 350 may change the size (or the length) of at least one of the first state area 1710a and the second state area 1720b included in the state graphic object 1422a based on an operational state of the robot located on a specific floor.

In some example embodiments of the present inventive concepts, the robot R providing services may provide services while vertically moving between different floors within the building 1000 including the plurality of floors 10a, 10b, and 10c. For example, the robot R may move vertically from a first specific floor (e.g., floor 1 (1F)) to another second specific floor (e.g., floor 2 (2F)).

According to some example embodiments of the present inventive concepts, a visual appearance of a state graphic object corresponding to each of the plurality of floors 10a, 10b, and 10c may be changed in conjunction with the movement of the robot R that moves vertically between the plurality of floors 10a, 10b, and 10c included in the building 1000.

As illustrated in the area labeled (a) of FIG. 19, when a specific robot R located on a first floor 1F has moved to a second floor 2F, the control unit 350 may change the size of the first state graphic object 1422a and the second state graphic object 1422b in conjunction with the movement of the specific robot R.

As illustrated in the area labeled (b) of FIG. 19, in conjunction with the specific robot R having moved from the first floor 1F to the second floor 2F, the control unit 350 may change the size of the first state graphic object 1422a from a size proportional to the number of robots R located on the first floor 1F (e.g., “three”, 1910) before the specific robot R moves to a size proportional to the number of robots R located on the first floor 1F (e.g., “two”, 1920) after the specific robot R moved. For example, the control unit 350 may decrease (or reduce) the size of the first state graphic object 1422a by a size proportional to the number of specific robots R that have moved.

In some example embodiments, as illustrated in the area labeled (b) of FIG. 19, in conjunction with the specific robot R having moved from the first floor 1F to the second floor 2F, the control unit 350 may change the size of the second state graphic object 1422b from a size proportional to the number of robots R located on the second floor 2F (e.g., “five”, 1930) before the specific robot R moves to a size proportional to the number of robots R located on the second floor 2F (e.g., “six”, 1940) after the specific robot R moved. For example, the control unit 350 may increase (or extend) the size of the second state graphic object 1422b by a size proportional to the number of specific robots R that have moved.

The control unit 350 may change the visual appearances of the first state graphic object 1422a and the second state graphic object 1422b when it is monitored that the specific robot R has moved from the first floor 1F to the second floor 2F, based on the robot information 1510 received from the specific robot R.

As described above, according to some example embodiments of the present inventive concepts, a size (or a length) and a visual appearance of a state graphic object corresponding to each of the plurality of floors 10a, 10b, and 10c in the building 1000 may be changed based on a location of the robot R and an operational state of the robot R that varies in real time. A user may intuitively recognize an overall current situation, such as the number of robots R operating on each of the plurality of floors 10a, 10b, and 10c in the building 1000 and the operational states of the robots R, through the monitoring screen 1400.

According to some example embodiments, e.g., as illustrated in FIG. 14, the third area 1430 may include statistical information graphic objects 1431, 1432, and 1433 that include statistical information on the robots R located in the building 1000.

The control unit 350 provides the statistical information graphic objects 1431, 1432, and 1433 in a card view, so that a user may quickly recognize various statistical information on one monitoring screen 1400 and have a stable aesthetic feeling for the monitoring screen 1400.

The statistical information graphic objects 1431, 1432, and 1433 may be represented by visual appearances corresponding to various statistical information processed based on the robot information 1510.

The third area 1430 may include at least one of the statistical information graphic objects 1431, 1432, and 1433, in which each of the statistical information graphic objects 1431, 1432, and 1433 may include different statistical information.

In some example embodiments, a first statistical information graphic object 1431 may include information on a robot (e.g., identification information on the robot, error, and a time point when the error occurred) that corresponds to a specific operational state (e.g., “error”) among a plurality of the robots R located in the building 1000. For example, the first statistical information graphic object 1431 may include information on error situations encountered by the robots R in the form of a timeline.

In some example embodiments, a second statistical information graphic object 1432 may include a visual appearance corresponding to quantity of the robots R that corresponds to a specific operational state for each time period. A user may identify an operational state current situation of the robots R for each time period at a glance through the second statistical information graphic object 1432.

In some example embodiments, a third statistical information graphic object 1433 may include icons 1433a and 1433b corresponding to facility infrastructures 200 that is operable in conjunction with the robot R. A user may be provided with detailed information on locations of the facility infrastructures 200 and current situations of operating in conjunction with the robots R by selecting the icons 1433a and 1433b included in the third statistical information graphic object 1433.

According to some example embodiments, when there is a user input for a specific area of the second area 1420 and the third area 1430, the control unit 350 may further provide information corresponding to the specific area where the user input is received on the monitoring screen 1400. A user may easily access more detailed information on locations of the robots R in the building 1000, an operational situation thereof, an operational states thereof, issues encountered in real time, current situations of operating in conjunction with the facility infrastructures 200, situations for each floor of the building 1000, and the like, through the monitoring screen 1400. Hereinafter, a method of accessing more detailed information on the robots R present in the building 1000 through the monitoring screen 1400, according to some example embodiments of the present inventive concepts, will be described.

According to some example embodiments of the present inventive concepts, an infrastructure or facility infrastructure is a facility provided in the building 1000 for the provision of services, the movement of robots, the maintenance of functionality, the maintenance of cleanliness, and the like, which may be of various types and forms.

For example, an infrastructure in a building may include mobility facilities (e.g., robotic pathways, elevators, escalators, etc.), charging facilities, communication facilities, cleaning facilities, structures (e.g., stairs, etc.), etc., but example embodiments are not limited thereto.

In the building 1000 according to some example embodiments of the present inventive concepts, at least one of the building 1000, various facility infrastructures 200 provided in the building 1000, and the robot R may be controlled in conjunction with each other so that the robot is able to safely and accurately provide various services in the building 1000.

In order to efficiently monitor and control the robots R providing services within the building 1000, it is also a very important or advantageous factor to efficiently monitor various facility infrastructures 200 of the building 1000 and relationship of operating in conjunction between the robots R and the facility infrastructures 200.

Accordingly, in some example embodiments of the present inventive concepts, the monitoring screen 1400 may provide operational current situation information on the facility infrastructures 200 according to at least one of the plurality of floors 10a, 10b, and 10c and types so that a user may intuitively recognize the operational situation of the facility infrastructures 200 located on each of the plurality of floors 10a, 10b, and 10c included in the building 1000.

As illustrated in FIG. 20, according to some example embodiments, the third area 1430 of the monitoring screen 1400 may include a plurality of infrastructure icons 1433a, 1433b, and 1433c corresponding to each of the plurality of facility infrastructures 200 present in the building 1000.

The control unit 350 may control, e.g., the monitoring screen 1400, based on any one of the plurality of infrastructure icons 1433a, 1433b, and 1433c being selected, such that locations of the facility infrastructures 200 corresponding to the selected infrastructure icons are represented on the second area 1420.

The control unit 350 may highlight a specific sub-graphic object 1421d corresponding to a floor on which a facility infrastructure (e.g., “robot-only elevator”, EV1) is located corresponding to a selected infrastructure icon (e.g., 1433a). For example, the control unit 350 may control, e.g, the monitoring screen 1400 such that a visual appearance of the specific sub-graphic object 1421d is represented differently than a visual appearance of another sub-graphic object 1421a.

The control unit 350 may control e.g., the monitoring screen, based on any one of the plurality of infrastructure icons 1433a, 1433b, and 1433c being selected, such that locations of the facility infrastructures 200 operating in conjunction (or linkage) with the robots R among the facility infrastructures 200 corresponding to the selected infrastructure icons are represented on the second area 1420.

The control unit 350 may highlight a specific sub-graphic object corresponding to a floor on which the facility infrastructure 200 operating in conjunction (or linkage) with the robots R is located among facility infrastructures (e.g., “robot-only elevator”) corresponding to a selected infrastructure icon (e.g., 1433a).

For example, the control unit 350 may highlight a sub-graphic object 1421e corresponding to a fifth floor when a robot-only elevator EV2 with the robot R on board is present on the fifth floor. In some example embodiments, when the robot R is not on board even if the robot-only elevator is present on a first floor, the control unit 350 may control such that the first sub-graphic object corresponding to the first floor is not highlighted.

In some example embodiments, the control unit 350 may identify, based on the collected facility information 1610 (see, e.g., FIG. 16A), information on a floor on which each of the facility infrastructures 200 is located, and a state of operating in conjunction with the robot R (or an operational state).

As described above, according to some example embodiments of the present inventive concepts, in the monitoring screen 1400, when a user intends to identify a floor on which a specific facility infrastructure (e.g., “robot-only elevator”) is located, the user may be provided with intuitive information on the floor on which the specific facility infrastructure (e.g., “robot-only elevator”) is located by selecting the infrastructure icon 1433a corresponding to the specific facility infrastructure in the third area 1430.

According to some example embodiments, in order to efficiently and systematically manage a plurality of robots R providing services in the building 1000, in addition to an integrated monitoring of an overall operational situation of the plurality of robots R located in the building 1000, it is also very important or advantageous factor to identify an operational situation of an individual robot R in detail and to perform control of the individual robot R.

Accordingly, in some example embodiments of the present inventive concepts, a user interface for controlling a map corresponding to a specific floor, a movement path of the robot R located on the specific floor, an operational state of the robot R located on the specific floor, and an operation of the robot R located on the specific floor may be provided for instantly responding to various situations, easily accessing individual control of the specific robot R, and intuitively controlling the robot R.

As illustrated in FIG. 21, the control unit 350 may control the display unit 330 such that a map or minimap corresponding to a specific floor is output on the monitoring screen 1400.

As illustrated in FIG. 21, according to some example embodiments of the present inventive concepts, at least one of the communication unit 310 and the input unit 340 may receive a user input of selecting the specific sub-graphic object 1421c among the plurality of sub-graphic objects 1421a, 1421b, and 1421c included on the monitoring screen 1400. The control unit 350 may, based on the user input, provide a map corresponding to a specific floor (e.g., floor 9) of the plurality of floors 10a, 10b, and 10c that corresponds to the specific sub-graphic object 1421c on the display unit 330.

Here, the map corresponding to the specific floor may be configured as a two-dimensional (2D) or three-dimensional (3D) image visualizing a space 10 corresponding to the specific floor.

A user may identify a map corresponding to a specific floor by selecting the specific sub-graphic object 1421c corresponding to the floor for which the user wants to be provided with detailed information.

In some example embodiments of the present inventive concepts, at least one of the communication unit 310 and the input unit 340 may receive a user input of selecting the specific state graphic object 1422c among the plurality of state graphic objects 1422a, 1422b, and 1422c included on the monitoring screen 1400. In some example embodiments of the present inventive concepts, at least one of the communication unit 310 and the input unit 340 may receive a user input of selecting a specific state graphic object (e.g., “9”) among a plurality of floor guide graphic objects included on the monitoring screen 1400.

As described above, according to some example embodiments, even when the user input to the specific state graphic object 1422c is received, the control unit 350 may provide the display unit 330 such that a map corresponding to a specific floor is provided on the monitoring screen 1400. However, hereinafter, for convenience of description, when any one of the plurality of sub-graphic objects 1421a, 1421b, and 1421c is selected, providing a map 2100 corresponding to a specific floor will be described as an example.

In some example embodiments, the storage unit 320 may have a map corresponding to each of the plurality of floors 10a, 10b, and 10c. The control unit 350 may control such that, based on receiving a user input for the specific sub-graphic object 1421c, a map 2100 corresponding to a specific floor present in the storage unit 320 is provided on the display unit 330.

In some example embodiments, the map 2100 corresponding to a specific floor (e.g., floor 9) may be positioned around the state graphic object 1422c corresponding to the specific floor.

The control unit 350 may link the map 2100 corresponding to a specific floor (e.g., floor 9) and the state graphic object 1422c corresponding to the specific floor to provide them on the monitoring screen 1400 so that which floor may be recognized to correspond to the map 2100 provided through the monitoring screen 1400.

These maps 2100 corresponding to specific floors may be provided in different positions on the monitoring screen 1400 in conjunction with different state graphic objects when the specific floors corresponding to the maps are different. For example, the map 2100 corresponding to the ninth floor may be positioned above a map corresponding to the first floor on the monitoring screen 1400 illustrated in FIG. 21, as the map 2100 is provided in conjunction with a state graphic object 1422c corresponding to the ninth floor.

In some example embodiments, in the map 2100 corresponding to a specific floor (e.g., floor 9), an indicator (graphical objects, icons, or indicators 2110, 2120, and 2130) corresponding to each of specific robots R located on the specific floor may be displayed.

At least one of a display position on the map 2100 and a display color may be determined for each of the indicators (graphical objects or icons, 2110, 2120, and 2130), based on a location and operational state of the corresponding specific robot R.

The control unit 350 may identify the robot information 1510 (see, e.g., FIG. 15A) on each of the specific robots R corresponding to the specific floor in order to display the indicators 2110, 2120, and 2130 that correspond to each of the specific robots R located on the specific floor on the map 2100 corresponding to the specific floor. In some example embodiments, the control unit 350 may identify the data sets 1520 and 1530 (see, e.g., FIG. 15B), which are grouped based on a specific floor.

The control unit 350 may determine at least one of the display position and display color of the indicators 2110, 2120, and 2130 corresponding to each of the specific robots R located on the specific floor, based on the robot information 1510.

In some example embodiments, the display position of the indicators 2110, 2120, and 2130 corresponding to each of the specific robots R located on the specific floor may be determined based on where the specific robots R are located on the specific floor.

For example, the display position of each of the indicators 2110, 2120, and 2130 may correspond to a point (e.g., location or area) corresponding to an actual point (e.g., location or area) where the specific robot R corresponding to each of the indicators 2110, 2120, and 2130 is located on the specific floor, on the map 2100 corresponding to the specific floor.

In some example embodiments, the display position of each of the indicators 2110, 2120, and 2130 may be updated in conjunction with a movement of the specific robot R corresponding to each of the indicators 2110, 2120, and 2130.

For example, each of the indicators 2110, 2120, and 2130 may be moved on the map 2100 corresponding to the specific floor, based on the movement of the specific robot R corresponding to each of the indicators 2110, 2120, and 2130 on the specific floor.

In some example embodiments, in the display color of the indicators 2110, 2120, and 2130 corresponding to each of the specific robots R, at least one of a color, design, shape, form, or pattern (hereinafter referred to as a “visual appearance”) may be represented differently depending on the operational state of each of the specific robots R. The display colors of the indicators 2110, 2120, and 2130 may be represented as visual appearances corresponding to the respective operational states of the specific robots R.

Information related to a visual appearance corresponding to the operational state of the robot R may be preset and exist in the storage unit 320. For example, visual appearances of the indicators 2110, 2120, and 2130 corresponding to the operational states of the robots R and visual appearances of the sub-state graphic objects 1711, 1712, and 1713 may be set to be the same.

For example, as illustrated in FIG. 21, a visual appearance of a first indicator 2110 corresponding to an operational state of “standby” and a visual appearance of a second indicator 2120 corresponding to an operational state of “performing” may be different from each other.

In some example embodiments, the display color of each of the indicators 2110, 2120, and 2130 may be updated in conjunction with an operational state of the specific robot R corresponding to each of the indicators 2110, 2120, and 2130.

More specifically, when the specific robot R corresponding to each of the indicators 2110, 2120, and 2130 changes from a first specific operational state to a second specific operational state, each of the indicators 2110, 2120, and 2130 may change from a visual appearance corresponding to the first specific operational state to a visual appearance corresponding to the second specific operational state.

Accordingly, in some example embodiments of the present inventive concepts, a map 2100 corresponding to a specific floor may be provided on the monitoring screen 1400. A user may identify (monitor or check) operation locations, movement paths, operational states, whether issues occur, or the like of the robots R existing on a specific floor through the map 2100 corresponding to the specific floor.

As illustrated in FIG. 22A, in some example embodiments, the display unit 330 may be controlled to output the map 2100 corresponding to a specific floor and detailed information 2210 on a specific robot R corresponding to a specific indicator 2110 together based on a user input corresponding to the specific indicator 2110 being received, on the map 2100 corresponding to the specific floor.

As illustrated in (a) of FIG. 22A, at least a portion of the map 2100 corresponding to the specific floor may include an overlapping sub-area A.

In the monitoring screen 1400, an area where the map 2100 corresponding to the specific floor is displayed may be referred to as a “map area”. For example, the monitoring screen 1400 may be described as including the map area 2100 and the sub-area A that overlaps at least a portion of the map area 2100.

A position where the sub-area A overlaps the map area (or map, 2100) may change based on a control of the control unit 350, a setting of the system administrator, or a user input. In some example embodiments, an output size of at least one of the map area (or map, 2100) and the sub-area A may also, of course, be changed based on a control of the control unit 350, a setting of the system administrator, or a user input.

The sub-area A may include detailed information 2210 of a specific robot R corresponding to a user input.

The control unit 350 may identify robot information on the specific robot R corresponding to a user input when the user input is received through at least one of the communication unit 310 and the input unit 340.

The control unit 350 may generate the detailed information 2210 on the specific robot R to be included in the sub-area A based on robot information on the specific robot R.

As illustrated in (b) of FIG. 22A, the detailed information on the specific robot R may include at least one of identification information that is specific to the specific robot R (e.g., “ARC 0033-2”), an operational state of the specific robot R (e.g., “performing” or “error or emergency stop”), battery information (e.g., battery level), communication state information, CPU usage rate information, current location information, departure information, destination information, departure time information, estimated arrival time information, and assigned (or performing) mission information.

In some example embodiments, the detailed information on the specific robot R may include a graphical object (or description information) corresponding to an operational state of the specific robot R. The graphic object (or description information) corresponding to a specific state may be preset for each of different operational states of the robot R and stored in the storage unit 320.

According to some example embodiments, when an operational state of the specific robot R corresponds to “performing a mission”, detailed information 2210a may include a graphical object 2211a or description information (e.g., “I'm fine”, 2212a) corresponding to the mission performance.

According to some example embodiments, when an operational state of the specific robot R corresponds to “error (or emergency stop)”, detailed information 2210b may include a graphical object 2211b or description information (e.g., “I'm Sick”, 2212b) corresponding to the mission performance.

Accordingly, in some example embodiments, a user may intuitively recognize an operational state and location of the specific robot R through the indicator 2110 included in the map 2100 corresponding to a specific floor, and may select the indicator 2210 to identify more detailed information.

As illustrated in (a) of FIG. 22B, in some example embodiments, sub-area B may overlap with at least a portion of the map 2100 corresponding to a specific floor, and the sub-area B may include a robot transmitted, provided, or sent image 2220a acquired by a specific robot R.

According to some example embodiments, the robot transmitted, provided, or sent image 2220a may include a spatial image collected from a camera (e.g., CCTV) disposed in a space where the specific robot R is located, as well as the image 2220a acquired by the specific robot itself.

When the robot transmitted, provided, or sent image 2220a is an image acquired by the specific robot R itself, the robot transmitted, provided, or sent image 2220a may be an image taken of an area corresponding to a direction of traveling (or direction of moving forward) of the specific robot R on a specific floor.

In some example embodiments, the direction of traveling can be a direction in which a front side of the robot is facing. For example, the area included in the robot transmitted, provided, or sent image may be an area that the front side of the robot R is looking at.

In some example embodiments, the control unit 350 may control movement of a robot R based on a predetermined, or alternatively desired user input to the map 2100 corresponding to a specific floor.

The control unit 350 may perform control of the specific robot R such that, in the map 2100 corresponding to the specific floor, at least one of a location of the specific robot R and a direction of traveling of the specific robot R is changed based on a predetermined, or alternatively desired user input to the specific indicator 2110.

For example, the control unit 350 may perform control of at least one of an actual location and a direction of traveling of the specific robot R in the map 2100 corresponding to the specific floor that is operatively in conjunction with a position and a direction of traveling of the specific indicator 2110.

In some example embodiments, when a user intends to control a specific robot R located on a specific floor to move from a first actual location to a second actual location, the user may move the indicator 2110 of the specific robot R located at a first point S1 corresponding to the first actual location to a second point S2 corresponding to the second actual location in the map 2100 corresponding to the specific floor. For example, a user may drag the indicator 2110 positioned at the first point S1 on the map 2100 corresponding to a specific floor to move the indicator 2110 to the second point S2.

The control unit 350 may control the specific robot R to move from the first actual location corresponding to the first point S1 to the second actual location corresponding to the second point S2 based on the position of the specific indicator 2110 changing from the first point S1 to the second point S2 in the map 2100 corresponding to the specific floor.

According to some example embodiments, as illustrated in (a) of FIG. 22B, when a predetermined, or alternatively desired user input to the map 2110 corresponding to a specific floor is received while the map 2110 and the robot transmitted, provided, or sent image 2220a corresponding to the specific floor are being output through the monitoring screen 1400, the control unit 350 may generate a control command to control a traveling of a robot in response to the user input.

In some example embodiments, the control unit 350 may transmit, provide, or send the control command to the specific robot R, such that the specific robot R travels according to the control command. The specific robot R receiving the control command may be controlled to travel according to the control command.

In some example embodiments, the control unit 350 may update the robot transmitted, provided, or sent image 2220a included in the sub-area B on the map 2100 corresponding to a specific floor based on the specific robot R moving. For example, the control unit 350 may control such that a robot transmitted, provided, or sent image 2220b acquired by the specific robot R at the second actual location is output on the sub-area B, based on the specific robot R moving from the first actual location to the second actual location.

Accordingly, in some example embodiments, a user may intuitively identify a direction of traveling of the specific robot R and the surrounding environment through the robot transmitted image 2220a output to the sub-area B, as well as intuitively recognize whether the specific robot R is moving.

According to some example embodiments of the present inventive concepts, a user interface may be provided that allows a user to intuitively control a location and direction of traveling of a specific robot R located on a specific floor, on the monitoring screen 1400.

A user may easily access an individual control of a specific robot R located on a specific floor through the monitoring screen 1400, in addition to integrally identifying an overall operational current situation of a plurality of the robots R present in the building 1000.

In some example embodiments, the control unit 350 may perform different controls (or different data processing) depending on which area on the monitoring screen 1400 a user input through the input unit 340 is applied to, while the map 2100 and robot transmitted, provided, or sent image 2220a corresponding to a specific floor are being output on the monitoring screen 1400.

For example, the control unit 350 may generate a control command to control movement of the robot R when the user input is applied to a map area (or the map, 2100) among the map area (or the map, 2100 corresponding to a specific floor) and sub-area B on the monitoring screen 1400.

In some example embodiments, the control unit 350 may perform control of the monitoring screen 1400 when the user input is applied to the sub-area B among the map area (or the map 2100 corresponding to a specific floor) and sub-area B on the monitoring screen 1400.

In some example embodiments, it may occur that a user wants to view the robot transmitted, provided, or sent image 2220a at a larger scale in order to identify the surrounding environment of the robot R through the robot transmitted, provided, or sent image 2220a. For example, in this case, the map 2100 corresponding to a specific floor and the robot transmitted, provided, or sent image 2220a output from the sub-area B may need to be mutually switched.

For example, as illustrated in (a) of FIG. 22C, when the user input is applied to the sub-area B among the map area (or the map 2100 corresponding to the specific floor) and sub-area B, the control unit 350 may control such that positions of the map 2100 corresponding to the specific floor and the robot transmitted, provided, or sent image 2220a are mutually switched to be included on the monitoring screen 1400.

In some example embodiments, when the user input is applied to the sub-area B again, the control unit 350 may control such that the positions of the map 2100 and the robot transmitted, provided, or sent image 2220a corresponding to the specific floor are mutually switched again to be included on the monitoring screen 1400.

Accordingly, in some example embodiments, a user may apply a first user input to the sub-area B when the user wants to view the robot transmitted, provided, or sent image 2220a at a larger scale, and a second user input to the sub-area B when the user wants to view again the map 2100 for a specific floor at a larger scale.

Accordingly, in some example embodiments of the present inventive concepts, a user interface may be provided that allows a user to monitor and control the robots R providing services within the building 1000 in an integrated manner.

In some example embodiments of the present inventive concepts, e.g., as illustrated in FIGS. 22D and 22E, the movement of the robot R may be controlled based on a predetermined, or alternatively desired user input to the robot transmitted, provided, or sent images 2220a and 2220c.

In some example embodiments, when the control unit 350 receives a predetermined, or alternatively desired user input to the robot transmitted, provided, or sent image 2220a, 2200c of a specific robot R, the control unit 350 may generate a control command to control traveling of the specific robot R in response to the user input. For example, the control unit 350 may generate the control command for controlling the traveling of the specific robot R such that at least one of a location of the specific robot R and a direction of traveling of the specific robot R is changed.

In some example embodiments, e.g., as illustrated in FIG. 22D, a user input may be applied to allow the specific robot R to travel forward from one direction to another direction (a direction toward D2 from D1) on the monitoring screen 1400, while the robot transmitted, provided, or sent image 2220a of the specific robot R is being output. The control unit 350 may generate a control command that controls the specific robot R to travel from one direction to another direction (the direction toward D2 from D1) based on the user input.

In some example embodiments, as illustrated in FIG. 22E, the control unit 350 may update the monitoring screen 1400 to include a robot transmitted, provided, or sent image 2220c that includes an area corresponding to another direction D2, based the specific robot R traveling forward from one direction to another direction (the direction toward D2 from D1).

In some example embodiments, e.g., as illustrated in FIG. 22F, the monitoring screen 1400 may further include a search area C for searching for a specific robot R located on a specific floor. Although not illustrated, in some example embodiments, the search area C may be displayed to overlap the map 2110 corresponding to a specific floor.

The control unit 350 may provide detailed information on the specific robot R based on information related to the specific robot R being input into the search area C.

For example, detailed information on a specific robot R may be provided even when information related to the specific robot R is input into the search area C, not only when any one of the plurality of indicators 2110, 2120, and 2130 included in the map 2100 corresponding to a specific floor is selected.

In some example embodiments, the control unit 350 may control such that when information related to a specific robot R is input into the search area C, the specific indicator 2110 is highlighted so that the specific indicator 2110 corresponding to the specific robot R related to the input information may be intuitively recognized. For example, the control unit 350 may allow a specific graphical object (e.g., a circle-shaped graphical object) to be displayed around the specific indicator 2110 to provide a location of the specific robot R that a user is searching for.

Accordingly, in some example embodiments of the present inventive concepts, a user may be provided with detailed information related to a location of a specific robot R through the search area C, even when the user is not aware of where the specific robot R is located in the map 2100 corresponding to a specific floor.

In some example embodiments of the present inventive concepts, e.g., as illustrated in FIGS. 23A, 23B, and 23C, an administration screen (or administrator page, 2300a, 2300b, or 2300c) may be provided that provides various detailed information on the robots R located within the building 1000.

Accordingly, in some example embodiments, user may quickly and intuitively recognize a large amount of data regarding the robots R, and efficiently operate and manage the robots R, by being provided in an integrated manner with various states and detailed situations of the robots R located in the building 1000 through the administration screen 2300a, 2300b, or 2300c.

For example, in the present inventive concepts, a user interface may be provided that allows a user to intuitively recognize and easily operate operational states, locations, whether an emergency situation has occurred, or the like of the robots R located in the building 1000.

In some example embodiments, e.g., as illustrated in FIG. 23A, the administration screen 2300a may include various information related to an overall operational current situation of a plurality of the robots R located within the building 1000. In some example embodiments, the administration screen 2300a may include, i) operational state statistical information generated by processing information on operational states of all the robots R located within the building 1000, and graphic objects 2310 corresponding to the operational state statistical information, ii) statistical information 2320 for a time period (e.g., information on a robot R that encountered an error during a specific time period, information on a robot R that completed an assigned mission, and information on a distance traveled by a robot), and iii) robot information 2330 received from each of the robots R.

In some example embodiments, e.g., as illustrated in FIG. 23B, the administration screen 2300b may include various information related to an operational current situation of a specific robots R located within the building 1000. For example, the administration screen 2300b may include, i) detailed information 2340 on a specific robot R, ii) activity history information 2350, iii) detailed profile information 2360 on the specific robot R, and iv) timeline information 2370 on issues encountered by the specific robot R.

In some example embodiments, as illustrated in FIG. 23C, the administration screen 2300c may include various information related to an operational current situation of facility infrastructure 200 located within the building 1000. For example, the administration screen 2300c may include, i) usage current situation information 2380 for each type of facility infrastructure; and ii) facility information 2390 collected in relation to the facility infrastructure.

As described above, according to some example embodiments, the method and system for monitoring a robot operation according to the present inventive concepts can provide a large amount of information on the robots located in the building through a single monitoring screen by receiving robot information from each of the robots and providing a monitoring screen for monitoring the operational situation of the robots located in the building through communication with robots located in the building. Therefore, a user can be provided with a large amount of information on the robots located in a building through a single screen in an integrated manner and systematically identify a situation in which the building is linked to the robots.

According to some example embodiments, the method and system for monitoring a robot operation according to the present inventive concepts can provide a monitoring screen that includes a building graphic object representing a building, and a state graphic object positioned around the building graphic object and representing state information on a robot located on each of a plurality of floors included in the building. Therefore, a user can perform integrated and efficient management across a plurality of robots located in a building by intuitively and quickly recognizing the number of robots operating on each floor of the building, a location of the robots, and an operational state of the robots with a just look at a single monitoring screen.

According to some example embodiments, in the method and system for monitoring a robot operation according to the present inventive concepts, state information on the robots included in the monitoring screen and a visual appearance of the state graphic object can be determined based on robot information received from each of the robots located in the building. Therefore, a user can monitor the location and operational state of multiple robots intuitively and in real-time and immediately respond to any robot-related issues through a single monitoring screen.

According to some example embodiments, a robot-friendly building according to the present inventive concepts can use technological convergence in which robotics, autonomous driving, AI, cloud technologies are fused and connected and provide a new space where these technologies, robots, and facility infrastructure provided in the building are organically combined.

According to some example embodiments, a robot-friendly building according to the present inventive concepts is capable of systematically managing a traveling of a robot providing services in a more systematic manner by organically controlling a plurality of robots and facility infrastructure using a cloud server that operates in conjunction with the plurality of robots. Therefore, the robot-friendly building according to the present invention can provide various services to humans more safely, quickly, and accurately.

According to some example embodiments, the robot applied to the building according to the present inventive concepts may be implemented in a brainless form controlled by the cloud server, according to which a large number of robots disposed in the building can be manufactured at a low cost without expensive sensors, and can be controlled with high performance and high precision.

According to some example embodiments, in a building according to the present inventive concepts, robots and humans can coexist naturally in the same space by controlling a traveling of the robots to take into account humans, in addition to taking into account tasks assigned to the plurality of robots disposed in the building and a situation in which the robots are moving.

According to some example embodiments, in the building according to the present inventive concepts, by performing various controls to prevent accidents by robots and respond to unexpected situations, it is possible to instill in humans the perception that robots are friendly and safe, rather than dangerous.

According to some example embodiments, the present inventive concepts described above may be executed by one or more processes on a computer and implemented as a program that can be stored on a computer-readable medium.

According to some example embodiments, the present inventive concepts described above may be implemented as computer-readable code or instructions on a medium in which a program is recorded. For example, the various control methods according to the present invention may be provided in the form of a program, either in an integrated or individual manner.

According to some example embodiments, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

According to some example embodiments, the computer-readable medium may be a server or cloud storage that includes storage and that the electronic device is accessible through communication. For example, the computer may download the program according to the present inventive concepts from the server or cloud storage, through wired or wireless communication.

According to some example embodiments of the present inventive concepts, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present inventive concepts should be determined based on the reasonable interpretation of the appended claims, and all of the modifications within the equivalent scope of the present inventive concepts belong to the scope of the present inventive concepts.

What is claimed is:

1. A method of monitoring a robot operation in a building in which robots provide services, the method comprising:
receiving robot information from each of the robots through communication with the robots located in the building; and
displaying, on a display unit, a monitoring screen configured to monitor an operational situation of the robots located in the building,
the monitoring screen including,
a building graphic object representing the building; and
a state graphic object positioned around the building graphic object, and the state graphic object representing state information on a robot located on each of a plurality of floors included in the building, the state information on the robot and a visual appearance of the state graphic object determined based on the robot information received from each of the robots.

2. The method of claim 1, wherein the building graphic object comprises a plurality of sub-graphic objects mapped to each of the plurality of floors, and
wherein the state graphic object comprises a plurality of state graphic objects representing state information on a robot for each specific floor mapped to each of the plurality of sub-graphic objects.

3. The method of claim 2, wherein the building graphic object comprises:
a first sub-graphic object mapped to a first floor of the plurality of floors; and
a second sub-graphic object mapped to a second floor of the plurality of floors,
wherein a first state graphic object representing state information on a robot located on the first floor mapped to the first sub-graphic object is located around the first sub-graphic object on the monitoring screen, and
wherein a second state graphic object representing state information on a robot located on the second floor mapped to the second sub-graphic object is located around the second sub-graphic object on the monitoring screen.

4. The method of claim 3, comprising:
determining which floor of the plurality of floors the robots located in the building are located on, based on the robot information; and
determining, based on a result of the determination, a visual appearance of each of the first state graphic object and the second state graphic object such that state information on the robots is represented in conjunction with a specific floor of the plurality of floors on which each of the robots is located.

5. The method of claim 4, wherein the visual appearance of each of the first state graphic object and the second state graphic object is different in at least one of size and color, depending on a number and operational state of the robots located on each of the first floor and the second floor.

6. The method of claim 5, wherein the size of each of the first state graphic object and the second state graphic object is determined in proportion to the number of robots located at each of the first state graphic object and the second state graphic object, and
wherein when a specific robot located on the first floor moves to the second floor, the size of the first state graphic object and the second state graphic object is configured to change in conjunction with the movement of the specific robot.

7. The method of claim 2, wherein each of the plurality of state graphic objects is configured to include any one of a plurality of state areas representing different states of the robots, and
wherein the plurality of state areas comprises at least one of
a first state area representing a first state corresponding to a state of a moving robot,
a second state area representing a second state corresponding to a state of a standby robot, and
a third state area representing a third state corresponding to a state of a robot in which an error exists.

8. The method of claim 7, wherein a size of each of the first state area, the second state area, and the third state area is determined depending on a state of each of robots located in a specific floor corresponding to a specific state graphic object including the first state area, the second state area, and the third state area among the plurality of floors.

9. The method of claim 8, wherein the size of each of the first state area, the second state area, and the third state area is proportional to each of a number of robots with the first state, a number of robots with the second state, and a number of robots with the third state among the robots located on the specific floor.

10. The method of claim 7, further comprising:
receiving a user input selecting any one of the first state area, the second state area, and the third state area; and
displaying, on the monitoring screen, a list of robots located on the specific floor and having a state corresponding to the state area selected by the user input, based on the user input.

11. The method of claim 2, further comprising:
receiving, on the monitoring screen, a user input of selecting a specific sub-graphic object of the plurality of sub-graphic objects; and
displaying, on the display unit, a map corresponding to a specific floor that corresponds to the specific sub-graphic object of the plurality of floors, based on the user input,
wherein an indicator corresponding to each of specific robots located on the specific floor is displayed on the map corresponding to the specific floor.

12. The method of claim 11, wherein a display position of the indicator corresponding to each of the specific robots located on the specific floor is determined based on where the specific robot is located on the specific floor.

13. The method of claim 12, wherein the display position of the indicator is updated in conjunction with movement of the specific robot on the specific floor.

14. The method of claim 12, wherein a display color of the indicator corresponding to each of the specific robots is displayed to vary depending on a state of each of the specific robots, and
wherein the state of each of the specific robots has one of a first state corresponding to a state of a standby robot, a second state representing a second state corresponding to a state of a moving robot, and a third state corresponding to a state of a robot in error.

15. A system for operating a robot in a building where robots provide services, the system comprising:
a communication unit configured to receive robot information from each of the robots through communication with the robots located in the building; and
a control unit configured to control a display unit to display a monitoring screen for monitoring an operational situation of the robots located in the building,
the monitoring screen including,
a building graphic object representing the building; and
a state graphic object positioned around the building graphic object, and the state graphic object representing state information on a robot located on each of a plurality of floors included in the building, the state information on the robot and a visual appearance of the state graphic object determined based on the robot information received from each of the robots.

16. A non-transitory computer-readable recording medium storing a program, the program, when executed by one or more processes on an electronic device, is configured to cause the electronic device to perform:
receiving robot information from each of robots through communication with the robots located in a building where the robots provide services; and
displaying, on a display unit, a monitoring screen configured to monitor an operational situation of the robots located in the building,
the monitoring screen including,
a building graphic object representing the building; and
a state graphic object positioned around the building graphic object, and the state graphic object representing state information on a robot located on each of a plurality of floors included in the building, the state information on the robot and a visual appearance of the state graphic object determined based on the robot information received from each of the robots.

17. A building where a plurality of robots provide services, the building comprising:
a plurality of floors having interior spaces in which the robots coexist with humans; and
a communication unit configured to perform communication between the robots and a cloud server,
the cloud server configured to receive robot information from each of the robots through communication with the robots located in the building, and display, on a display unit, a monitoring screen, the monitoring screen configured to monitor an operational situation of the robots located in the building,
the monitoring screen including,
a building graphic object representing the building; and
a state graphic object positioned around the building graphic object, and the state graphic object representing state information on a robot located on each of a plurality of floors included in the building, the state information on the robot and a visual appearance of the state graphic object determined based on the robot information received from each of the robots.
